(19) United States
(12) Patent Application Publication
(10) Pub. No.: US 2008/0089317 A1
(43) Pub. Date: Apr. 17, 2008

(54) CALL CONTROL SYSTEM, COMMUNICATION TERMINAL, CRITERIA VALUE DATA MEMORY APPARATUS AND RECORDING MEDIUM STORING PROGRAM

(75) Inventors: Masahiko Murakami, Kawasaki (JP); Satoshi Okuyama, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 11/872,174

(22) Filed: Oct. 15, 2007

(30) Foreign Application Priority Data
Oct. 16, 2006 (JP) 2006-281905

(51) Int. Cl. H04L 12/66

(52) U.S. Cl. 370/352

(57) ABSTRACT

A call control system, which is provided with a communication controlling part that controls calls of telephone sets such that the telephone receives transmitting data sent by the telephone, includes: a transmitting terminal evaluating part that is provided in the telephone set and calculates an evaluation score of the telephone set; the criteria score data memory part that stores a criteria score of the telephone set; a criteria score data updating part that increases and decreases the criteria score of the telephone set based on the evaluation score of the telephone set; and a transmission penalty memory part that stores transmission penalty data according to each step of the criteria score of the telephone set provided in a plurality of the steps, and the communication controlling part extracts the transmission penalty data stored in the transmission penalty memory part based on the criteria score of the telephone set and provides the transmission penalty to the transmitting data sent by the telephone set.

### BACKGROUND OF THE INVENTION

1. Field of the Invention

The present invention relates to a call control system, a communication terminal, a criteria value data memory apparatus and a recording medium that stores a program, and specifically relates to a call control system that controls calls of a transmitting terminal and a receiving terminal such that the receiving terminal receives transmitting data including call control data or voice data sent by the transmitting terminal, a communication terminal, a criteria value data memory apparatus and a recording medium that stores a program.

2. Description of Related Art

Recently, according to the development of internet-related techniques, IP (Internet Protocol) telephones utilizing the internet have been prevailed. The IP telephones are communication terminals that realize voice communication by a VoIP (Voice over IP) by transmitting and receiving voice data via an IP telephone network. The IP telephones draw much attention because the communication cost thereof is lower than the case of utilizing a general public telephone network, and not only companies but also private users have been introduced the IP telephones increasingly.

Since the IP is a general communication protocol in communication between computers, the use of an IP telephone can constitutes a cooperating function with the computer flexibly. By cooperating the IP telephone and the computer, for example, a function of enabling that the IP telephone to transmit automatically to a plurality of telephone numbers designated by the computer can be realized.

By utilizing the automatically transmitting function of the IP telephone due to the cooperating function with the computer, an increase of telephone calls that are not desired by receivers (hereinafter, called “unwanted calls”) such as sales campaigns of forward trading, qualification sales, single-ring-and-hang-up calls, one-sided sales and silent calls is concerned. Due to the increase of the unwanted calls, telecommunication carriers (carriers) are required to solve the problems, which may lead to the deterioration of their productivities.

In order to solve these problems, JP 2005-333417 A discloses a structure in which an IP telephone is provided with an evaluation input notifying part. More specifically, after receiving an unwanted call, an user of the IP telephone inputs predetermined evaluation information into the IP telephone. The evaluation input notifying part of the IP telephone sends the input evaluation information with information about the transmitter of the unwanted call to a call control server. The call control server stores the evaluation information by corresponding to the transmitter of the unwanted call. When the transmitter of the unwanted call transmits again, a differentiation controlling part of the call control server performs control to change quality of a service, a charging condition and the like according to the evaluation information.

JP 2003-18324 A discloses a structure in which an IP telephone is provided with an evaluation parameter designating means. More specifically, after receiving an unwanted call, an user of the IP telephone inputs predetermined evaluation information into the IP telephone via the evaluation parameter designating means. The IP telephone sends the input evaluation information with information of the transmitter of the unwanted call to a transmitter evaluation parameter memory apparatus. The transmitter evaluation parameter memory apparatus stores the evaluation information by corresponding the transmitter of the unwanted call. When the transmitter of the unwanted call transmits again, the IP telephone extracts the evaluation information that is stored in the transmitter evaluation parameter memory apparatus, and performs processing of rejecting the reception according to the extracted evaluation information.

However, in JP 2005-333417 A and JP 2003-18324 A described above, the user of the IP telephone that receives the unwanted call is required to input the predetermined evaluation information into the IP telephone, thereby charging the user with much time and labor. Thus, the user of the IP telephone may not input the evaluation information. Moreover, even in the case of inputting the evaluation information, since the relative evaluation information is input by the users, the evaluation information varies according to each user.

Thus, according to JP 2005-333417 A and JP 2003-18324 A described above, the number of transmissions of unwanted calls cannot be reduced surely.

### SUMMARY OF THE INVENTION

Therefore, with the foregoing in mind, it is an object of the present invention to provide a call control system that can decrease the number of transmissions of unwanted calls surely without charging a user with much time and labor, a communication terminal, a criteria value data memory apparatus and a recording medium that stores a program.

In order to attain the above-mentioned object, the call control system of the present invention is a call control system including a communication controlling part that controls calls of a transmitting terminal and a receiving terminal such that the receiving terminal receives transmitting data including call control data or voice data sent by the transmitting terminal, the call control system including: a monitoring part that monitors a state of transmitting data received by the receiving terminal; an evaluation data memory part that stores evaluation item data showing an evaluation item of the transmitting data and evaluation item value data showing an evaluation value of the evaluation item; an extracting part that extracts the evaluation item value data stored in the evaluation data memory part based on a result of monitoring by the monitoring part; a transmitting terminal evaluating part that calculates an evaluation value of the transmitting terminal based on the evaluation item value data extracted by the extracting part; a criteria value data memory part that stores criteria value data showing a criteria value of the transmitting terminal serving as a criteria to control the calls of the transmitting terminal and the receiving terminal; a updating part that increases and decreases the criteria value of the transmitting terminal based on the evaluation value of the transmitting terminal calculated by the transmitting terminal evaluating part; and a transmission penalty memory part that stores a transmission penalty data providing a transmission penalty to the transmitting data sent by the transmitting terminal according to each step of the criteria value of the transmitting terminal provided in a plurality of the steps, wherein the communication controlling part extracts the transmission penalty data stored in the transmission penalty memory part based on the criteria value of the transmitting terminal, and provides the transmission penalty to the transmitting data sent by the transmitting terminal-According to the call control system of the present invention, the monitoring part monitors the state of the transmitting data that is received by the receiving terminal. The extracting part extracts the evaluation item value data stored in the evaluation data memory part based on the monitoring result by the monitoring part. The transmitting terminal evaluating part calculates the evaluation value of the transmitting terminal based on the evaluation item value data extracted by the extracting part. Thereby, unlike the above-described conventional structure, it is not necessary for the user of the receiving terminal to input the evaluation value of the transmitting terminal. Thus, it does not charge the user of the receiving terminal with much time and labor. Moreover, since the evaluation value of the transmitting terminal is calculated based on the evaluation item value data that is stored in the evaluation data memory part, the evaluation values of the transmitting terminal do not vary according to the respective users of the receiving terminal, unlike the above-described conventional structure. Moreover, the updating part increases and decreases the criteria value of the transmitting terminal that is stored in the criteria value data memory part based on the evaluation value of the transmitting terminal calculated by the transmitting terminal evaluating part. The communication controlling part extracts the transmission penalty data stored in the transmission penalty memory part based on the criteria value of the transmitting terminal, and provides the transmission penalty to the transmitting data sent by the transmitting terminal. Examples of the transmission penalty include a transmission delay from the transmitting terminal to the receiving terminal, a reply of a busy state of the receiving terminal to the transmitting terminal with respect to the transmission from the transmitting terminal to the receiving terminal and the like, but it is not limited to these. Thus, the number of the transmissions of unwanted calls can be decreased surely.

In the call control system of the present invention described above, it is preferably that the transmission penalty memory part stores a delay time of the call control data shown by the transmission penalty data that delays the call control data sent by the transmitting terminal stepwise, in each step of the criteria value of the transmitting terminal provided in the plurality of the steps, and the communication controlling part extracts the transmission penalty data stored in the transmission penalty memory part based on the criteria value of the transmitting terminal, and maintains the call control data sent by the transmitting terminal based on the delay time of the call control data shown by the transmission penalty data.

According to the structure described above, the communication controlling part extracts the transmission penalty data stored in the transmission penalty memory part based on the criteria value of the transmitting terminal. Thereby, the communication controlling part can extract the transmission penalty data depending on the increase or decrease of the criteria value of the transmitting terminal. Moreover, the communication controlling part maintains the call control data sent by the transmitting terminal based on the delay time of the call control data shown by the transmission penalty data. Thereby the transmission from the transmitting terminal to the receiving terminal is delayed. Thus, the number of the transmissions of unwanted calls can be decreased surely.

In the call control system of the present invention described above, it is preferable that the transmission penalty memory part stores a probability of a busy state shown by the transmission penalty data that inserts a busy message into the call control data sent by the transmitting terminal stepwise, in each step of the criteria value of the transmitting terminal provided in the plurality of the steps, and the communication controlling part extracts the transmission penalty data stored in the transmission penalty memory part based on the criteria value of the transmitting terminal, and inserts the busy message into the call control data sent by the transmitting terminal based on a probability of the busy state shown by the transmission penalty data.

According to the structure described above, the communication controlling part extracts the transmission penalty data stored in the transmission penalty memory part based on the criteria value of the transmitting terminal. Thereby, the communication controlling part can extract the transmission penalty data depending on the increase or decrease of the criteria value of the transmitting terminal. Moreover, the communication controlling part inserts a busy message into the call control data sent by the transmitting terminal, based on a probability of the busy state shown by the transmission penalty data. Thereby, the busy state of the receiving terminal can be replied to the transmitting terminal, with respect to the transmission from the transmitting terminal to the receiving terminal. Thereby, the number of the transmissions of unwanted calls can be decreased surely.

In the call control system of the present invention described above, it is preferable that the monitoring part includes an uttering judging part that monitors at least one state of an uttering state in which the transmitter of the transmitting terminal utters and a communicating state between the transmitter of the transmitting terminal and the receiver of the receiving terminal.

According to the structure described above, the uttering judging part monitors at least one of an uttering state of the transmitter and an communicating state between the transmitter and receiver. For example, the uttering judging part judges whether the transmitter utters one-sidedly or not, whether the transmitter is silent or not, and whether the communication is cut while the transmitter is uttering or not, based on the uttering state of the transmitter. Moreover, for example, the uttering judging part judges whether a communicating time is shorter than a predetermined time or not based on the communicating state between the transmitter and the receiver. Moreover, judgment items to be judged by the uttering judging part are not limited to these. Thereby, the uttering judging part can judge whether the transmission of the transmitting terminal is an unwanted call or not, based on at least one of the uttering state of the transmitter and the communicating state between the transmitter and the receiver.

In the call control system of the present invention described above, it is preferable that, in a case where the uttering judging part judges that communication between the transmitter and the receiver is normal communication based on at least one state of the uttering state and the communicating state, the uttering terminal evaluating part calculates an evaluation value of the transmitting terminal so as not to provide the transmission penalty to the transmitting data sent by the transmitting terminal.

According to the structure described above, in the case where the uttering judging part judges that the communication between the transmitter and the receiver is normal communication, the transmitting terminal evaluating part calculates the evaluation value of the transmitting terminal so as not to provide the transmission penalty to the transmitting data sent by the transmitting terminal. For example, the transmitting terminal evaluating part calculates the evaluation value of the transmitting terminal so as to decrease a transmission delay time from the transmitting terminal to the receiving terminal. Moreover, for example, the transmitting terminal evaluating part calculates the evaluation value of the transmitting terminal so as to decrease a probability of replying a busy state of the receiving terminal to the transmitting terminal, with respect to the transmission from the transmitting terminal to the receiving terminal. Thereby, in the case where the uttering judging part judges that the transmission of the transmitting terminal is not an unwanted call but a normal call (normal communication), the evaluation value of the transmitting terminal can be calculated so as not to provide the transmission penalty to the transmitting data that is sent by the transmitting terminal.

It is preferable that the call control system of the present invention described above includes a telephone directory data recording part that stores telephone directory data showing a telephone number corresponding to a full name or a name, wherein the monitoring part includes a telephone directory searching part that extracts the telephone number of the transmitting terminal from the call control data sent by the transmitting terminal, and judges whether the telephone number of the transmitting terminal is stored in the telephone directory data recording part or not.

According to the structure described above, the telephone directory searching part judges whether the telephone number of the transmitting terminal is stored in the telephone directory data memory part or not. Thereby, depending on whether the telephone number of the transmitting terminal is stored in the telephone directory data memory part or not, the evaluation value of the transmitting terminal can be increased or decreased.

In the call control system of the present invention described above, it is preferable that the monitoring part includes a call judging part that judges whether the call control data sent by the transmitting terminal shows establishment of the calls of the transmitting terminal and the receiving terminal or not.

According to the structure described above, the call judging part judges whether the call control data shows establishment of the calls of the transmitting terminal and the receiving terminal or not. That is, the call judging part judges whether the transmission of the transmitting terminal is a so-called single-ring-and-hang-up call or not. Thereby, it can judge whether the transmission of the transmitting terminal is an unwanted call or not. It should be noted that the single-ring-and-hang-up call is a kind of an unwanted call that utilizes a reception history displaying function of the receiving terminal, which is, for example, a call that is hung up after one or two rings so as to generate an imperfect call deliberately.

In order to attain the object described above, the communication terminal of the present invention is a receiving terminal using in a call control system, the call control system including: a communication controlling part that controls calls of a transmitting terminal and the receiving terminal such that the receiving terminal receives transmitting data including call control data or voice data sent by the transmitting terminal; a criteria value data memory part that stores criteria value data showing a criteria value of the transmitting terminal serving as a criteria that controls the calls of the transmitting terminal and the receiving terminal; a updating part that increases and decreases the criteria value of the transmitting terminal; and a transmission penalty memory part that stores transmission penalty data providing a transmission penalty to the transmitting data sent by the transmitting terminal according to each step of the criteria value of the transmitting terminal provided in a plurality of the steps, the communication terminal including: a monitoring part that monitors a state of the transmitting data received by the receiving terminal; an evaluation data memory part that stores evaluation item data showing an evaluation item of the transmitting data and evaluation item value data showing an evaluation value of the evaluation item; an extracting part that extracts the evaluation item value data stored in the evaluation data memory part based on a result of monitoring by the monitoring part; a transmitting terminal evaluating part that calculates the evaluation value of the transmitting terminal based on the evaluation item value data extracted by the extracting part; and a sending part that sends the evaluation value of the transmitting terminal calculated by the transmitting terminal evaluating part to the updating part.

In order to attain the object described above, the criteria value data memory apparatus of the present invention is a criteria value data memory apparatus using in a call control system, the call control system including: a communication controlling part that controls calls of a transmitting terminal and a receiving terminal such that the receiving terminal receives transmitting data including call control data or voice data sent by the transmitting terminal; a monitoring part that monitors a state of the transmitting data received by the receiving terminal; an evaluation data memory part that stores evaluation item data showing an evaluation item of the transmitting data and evaluation item value data showing an evaluation value of the evaluation item; an extracting part that extracts the evaluation item value data stored in the evaluation data memory part based on a result of monitoring by the monitoring part; a transmitting terminal evaluating part that calculates the evaluation value of the transmitting terminal based on the evaluation item value data extracted by the extracting part; and a transmission penalty memory part that stores transmission penalty data providing a transmission penalty to the transmitting data sent by the transmitting terminal according to each step of the criteria value of the transmitting terminal provided in a plurality of the steps, the criteria value data memory apparatus including: a criteria value data memory part that stores criteria value data showing a criteria value of the transmitting terminal serving as a criteria to control the calls of the transmitting terminal and the receiving terminal; and a updating part that increases and decreases the criteria value of the transmitting terminal based on the evaluation value of the transmitting terminal calculated by the transmitting terminal evaluating part.

In order to attain the object described above, the criteria value data memory apparatus of the present invention is a criteria value data memory apparatus using in a call control system, the call control system including: a communication controlling part that controls calls of a transmitting terminal and a receiving terminal such that the receiving terminal receives transmitting data including call control data or voice data sent by the transmitting terminal; and a monitoring part that monitors a state of the transmitting data received by the receiving terminal, the criteria value data memory apparatus including: an evaluation data memory part that stores evaluation item data showing an evaluation item of the transmitting data and evaluation item value data showing an evaluation value of the evaluation item; an extracting part that extracts the evaluation item value data stored in the evaluation data memory part based on a result of monitoring by the monitoring part; a transmitting terminal evaluating part that calculates the evaluation value of the transmitting terminal based on the evaluation item value data extracted by the extracting part; a criteria value data memory part that stores criteria value data showing a criteria value of the transmitting terminal serving as a criteria to control the calls of the transmitting terminal and the receiving terminal; a updating part that increases and decreases the criteria value of the transmitting terminal based on the evaluation value of the transmitting terminal calculated by the transmitting terminal evaluating part; and a transmission penalty memory part that stores transmission penalty data providing a transmission penalty to the transmitting data sent by the transmitting terminal according to each step of the criteria value of the transmitting terminal provided in a plurality of the steps.

Incidentally, the criteria value data memory apparatus of the present invention obtains the same effects as those of the call control system described above, and further obtains effects described below.

That is, the criteria value data memory apparatus of the present invention is provided with the evaluation data memory part, the criteria value data memory part and the transmission penalty memory part collectively. Since the criteria value data memory apparatus is provided with these memory parts collectively, an administrator can perform maintenances of these memory parts easily. For example, in the case of changing the evaluation item value data stored in the evaluation data memory part, it is necessary to change the evaluation item value data stored in the evaluation data memory part of the receiving terminal for each receiving terminal, according to the structure where the evaluation data memory part is provided in the receiving terminal. On the other hand, according to the criteria value data memory apparatus of the present invention, since the evaluation data memory part is provided in the criteria value data memory apparatus, it is necessary to change only the evaluation item value data stored in this evaluation data memory part.

In order to attain the object described above, the call controlling method of the present invention is a call controlling method in which a call control system controls calls of a transmitting terminal and a receiving terminal such that a receiving terminal receives transmitting data sent by the transmitting terminal, the call control system including: an evaluation data memory part that stores evaluation item data showing an evaluation item of the transmitting data including call control data or voice data sent by the transmitting terminal and evaluation item value data showing an evaluation value of the evaluation item; a criteria value data memory part that stores criteria value data showing a criteria value of the transmitting terminal serving as a criteria to control the calls of the transmitting terminal and the receiving terminal; and a transmission penalty memory part that stores transmission penalty data providing a transmission penalty to the transmitting data sent by the transmitting terminal according to each step of the criteria value of the transmitting terminal provided in a plurality of the steps, the call controlling method including: a monitoring operation of monitoring a state of the transmitting data received by the receiving terminal; an extracting operation of extracting the evaluation item value data stored in the evaluation data memory part based on a result of the monitoring in the monitoring operation; a transmitting terminal evaluating operation of calculating the evaluation value of the transmitting terminal based on the evaluation item value data extracted in the extracting operation; a updating operation of increasing and decreasing the criteria value of the transmitting terminal based on the evaluation value of the transmitting terminal calculated in the transmitting terminal evaluating operation; and a communication controlling operation of extracting the transmission penalty data stored in the transmission penalty memory part based on the criteria value of the transmitting terminal and providing the transmission penalty to the transmitting data sent by the transmitting terminal.

In order to attain the object described above, the recording medium storing the program of the present invention allows one or a plurality of computers to execute communication control processing of controlling calls of a transmitting terminal and a receiving terminal such that the receiving terminal receives transmitting data sent by the transmitting terminal, the computer including: an evaluation data memory part that stores evaluation item data evaluation item data showing an evaluation item of the transmitting data including call control data or voice data sent by the transmitting terminal and evaluation item value data showing an evaluation value of the evaluation item; a criteria value data memory part that stores criteria value data showing a criteria value of the transmitting terminal serving as a criteria to control the calls of the transmitting terminal and the receiving terminal; and a transmission penalty memory part that stores transmission penalty data providing a transmission penalty to the transmitting data sent by the transmitting terminal according to each step of the criteria value of the transmitting terminal provided in a plurality of the steps, the program allowing the computer to execute: monitor processing of monitoring a state of the transmitting data received by the receiving terminal; extraction processing of extracting the evaluation item value data stored in the evaluation data memory part based on a result of the monitoring in the monitor processing; transmitting terminal evaluation processing of calculating an evaluation value of the transmitting terminal based on the evaluation item value data extracted in the extraction processing; and update processing of increasing and decreasing the criteria value of the transmitting terminal based on the evaluation value of the transmitting terminal calculated in the transmitting terminal evaluation processing,

wherein the communication control processing allows the computer to execute processing of extracting the transmission penalty data stored in the transmission penalty memory part based on the criteria value of the transmitting terminal and providing the transmission penalty to the transmitting data sent by the transmitting terminal.

Moreover, in order to attain the object described above, the recording medium storing the program of the present invention allows a computer to function as the criteria value data memory apparatus according to claim 9, wherein the program allows the computer to execute: criteria value data storing processing of storing the criteria value data showing the criteria value of the transmitting terminal serving as the criteria to control the calls of the transmitting terminal and the receiving terminal into the criteria value data memory part; and update processing of increasing and decreasing the criteria value of the transmitting terminal based on the evaluation value of the transmitting terminal calculated by the transmitting terminal evaluating part.

These and other advantages of the present invention will become apparent to those skilled in the art upon reading and understanding the following detailed description with reference to the accompanying figures.

### BRIEF DESCRIPTION OF THE DRAWINGS

FIG. 1 is a block diagram showing a schematic structure of a call control system according to Embodiment 1 of the present invention.

FIG. 2 is a block diagram showing a detailed structure of a telephone set serving as a receiving terminal in the call control system described above.

FIG. 3 is a conceptional view showing an example of a voice waveform of voice data and a state of sampling this voice waveform at every certain period of time.

FIG. 4 is a view showing an example of a data structure of an uttering time memory part in the telephone set described above.

FIG. 5 is a view showing an example of a data structure of a telephone directory data memory part in the telephone set described above.

FIG. 6 is a view showing an example of a data structure of an evaluation data memory part in the telephone set described above.

FIG. 7 is a view showing an example of a data structure of a criteria score data memory part in a criteria score data memory apparatus of the call control system described above.

FIG. 8 is a view showing an example of a data structure of a criteria score data memory part before being updated by a criteria score data updating part of the criteria score data memory apparatus described above.

FIG. 9 is a view showing an example of a data structure of the criteria score data memory part after being updated by the criteria score data updating part described above.

FIG. 10 is a view showing an example of a data structure of a user data memory part in a call control server of the call control system described above.

FIG. 11 is a view showing an example of a data structure of a transmission penalty memory part in the call control server described above.

FIG. 12 is a view showing an example of a data structure of a corresponding data memory part in the call control server described above.

FIG. 13 is a block diagram showing a schematic structure in a modified example of the call control system described above.

FIG. 14 is a flow chart showing an example of an operation of the telephone set described above.

FIG. 15 is a flow chart showing an example of an operation of an evaluation item score data extracting part of the telephone set described above.

FIG. 16 is a flow chart showing an example of an operation of the criteria score data memory apparatus described above.

FIG. 17 is a flow chart showing an example of an operation of the call control server described above.

FIG. 18 is a block diagram showing a schematic structure of a call control system according to Embodiment 2 of the present invention.

FIG. 19 is a view showing an example of a data structure of a transmission penalty memory part in a call control server of the call control system described above.

FIG. 20 is a flow chart showing an example of an operation of the call control server described above.

FIG. 21 is a block diagram showing a schematic structure of a call control system according to Embodiment 3 of the present invention.

FIG. 22 is a block diagram showing a detailed structure of a telephone set serving as a receiving terminal in the call control system described above.

FIG. 23 is a block diagram showing a schematic structure of a call control system according to Embodiment 4 of the present invention.

### DETAILED DESCRIPTION OF THE INVENTION

More specific embodiments of the present invention will be described below in detail with reference to the drawings.

### Embodiment 1

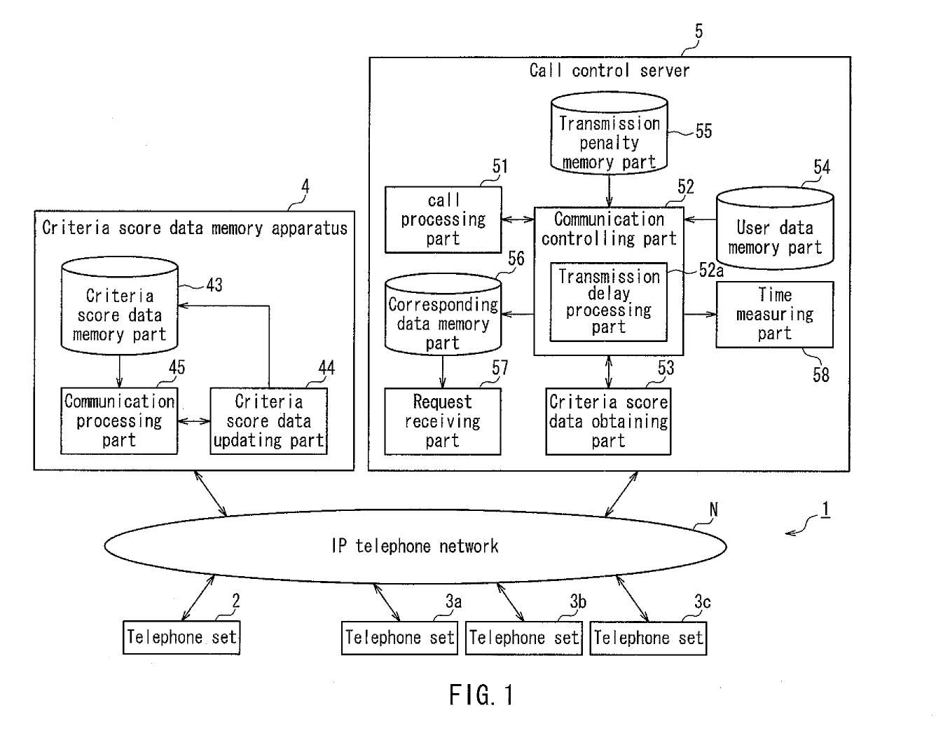

FIG. 1 is a block diagram showing a schematic structure of a call control system 1 according to the present embodiment. The call control system 1 according to the present embodiment is provided with telephone sets 2, 3a to 3c, a criteria score data memory apparatus 4 and a call control server 5. The telephone sets 2, 3a to 3c, the criteria score data memory apparatus 4 and the call control server 5 are connected to one another via an IP telephone network N. The telephone sets 2, 3a to 3c are communication terminals that realize voice communication by a VoIP (Voice over IP) by transmitting and receiving transmitting data including call control data or voice data via the IP telephone network N. The criteria score data memory apparatus 4 is an apparatus that stores criteria score data showing a criteria score of a transmitting terminal serving as a criteria to control calls of the transmitting terminal and a receiving terminal. The call control server 5 is a server that controls start, change and completion of the communication between two or more telephone sets among a plurality of the telephone sets including the telephone sets 2, 3a to 3c by using an SIP (Session Initiation Protocol), for example. Also, instead of the SIP, a MGCP (Media Gateway Control Protocol), which is a communication protocol of the standard H.323, may be used.

Moreover, in FIG. 1, the four telephone sets 2, 3a to 3c, the one criteria score data memory apparatus 4 and the one call control server 5 are illustrated for simplifying the explanation, but the number of the telephone sets 2, 3a to 3c, the criteria score data memory apparatus 4 and the call control server 5 that constitute the call control system 1 is arbitrary. Also, on the call control system 1, a web server, a proxy server, a DNS (Domain Name System) server, a DHCP (Dynamic Host Configuration Protocol) server or the like may be present. Moreover, it is also possible that a gateway may be present on the call control system 1, and a public switched telephone network may be connected via this gateway. Further, a router may be present on the call control system 1, and other IP telephone network may be connected via this router.

In the present embodiment, as an example, a case where a transmitter of unwanted calls transmits the unwanted calls to the telephone sets (receiving terminals, communication terminals) 3a to 3c by using the telephone set (transmitting terminal) 2 will be explained. Incidentally, in the present embodiment, it is assumed that the transmitter of the unwanted calls transmits the unwanted calls to the telephone sets 3a, 3b and 3c in this order, by using the telephone set 2.

(Structure of Receiving Terminal)

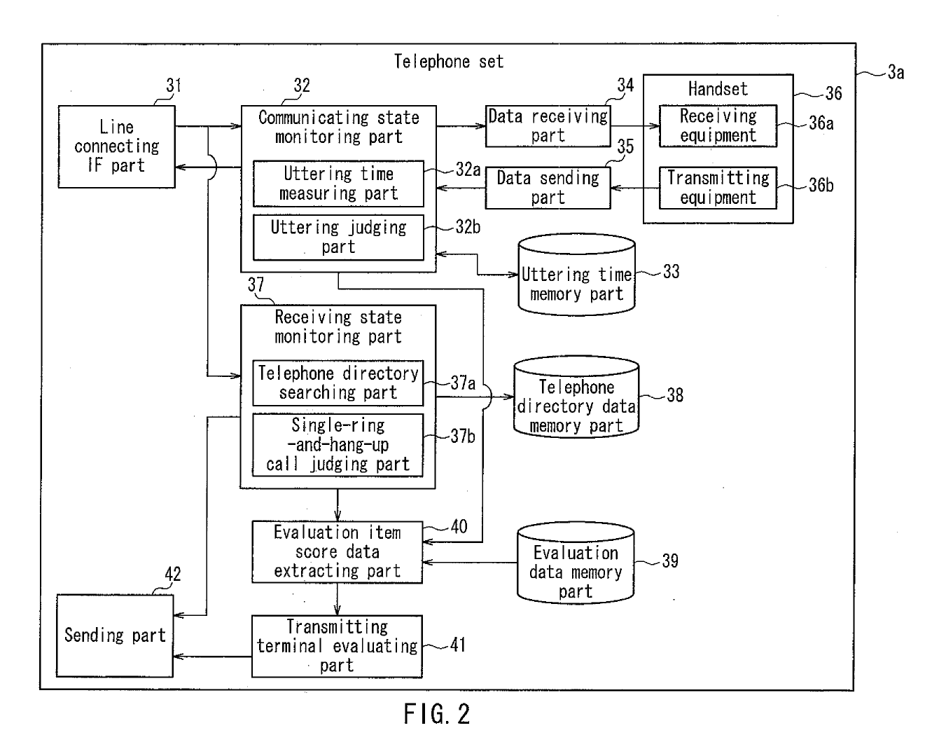

FIG. 2 is a block diagram showing a detailed structure of the telephone set (receiving terminal, communication terminal) 3a. Structures of the telephone sets 3b, 3c are the same as the structure of the telephone set 3a shown in FIG. 2. The telephone set 3a is provided with a line connecting interface part line connecting IF part in the figure) 31, a communicating state monitoring part 32, an uttering time memory part 33, a data receiving part 34, a data sending part 35, a handset 36, a receiving state monitoring part 37, a telephone directory data memory part 38, an evaluation data memory part 39, an evaluation item score data extracting part 40, a transmitting terminal evaluating part 41 and a sending part 42. Incidentally, the telephone set 3a may be either a mobile telephone set or a fixed telephone set.

The line connecting interface part 31 is an interface part that can receive call control data including a calling message sent from the telephone set 2. Moreover, the line connecting interface part 31 is an interface part that can receive voice data showing an uttering content of this transmitter (hereinafter, called “input voice data”) in the case where the transmitter of the telephone set 2 utters. Further, the line connecting interface part 31 is an interface part that can sent voice data showing an uttering content of this receiver (hereinafter, called “output voice data”), in the case where the receiver of the telephone set 3a utters by using the handset 36. The input voice data and the output voice data are communicated between the telephone set 2 and the line connecting interface part 31 in a form that accords with an RTP (Real-time Transport Protocol), for example. The line connecting interface part 31 outputs the call control data to the receiving state monitoring part 37. Moreover, the line connecting interface part 31 outputs the input voice data to the communicating state monitoring part 32. It should be noted that the input voice data and the output voice data will be explained as voice data simply, in the case where it is not necessary to distinguish the input voice data and the output voice data particularly, or in the case of calling them generically.

The communicating state monitoring part (monitoring part) 32 monitors states of the input voice data that is output from the line connecting interface part 31 and the output voice data that is output from the data sending part 35. Thus, the communicating state monitoring part 32 is provided with an uttering time measuring part 32a and an uttering judging part 32b.

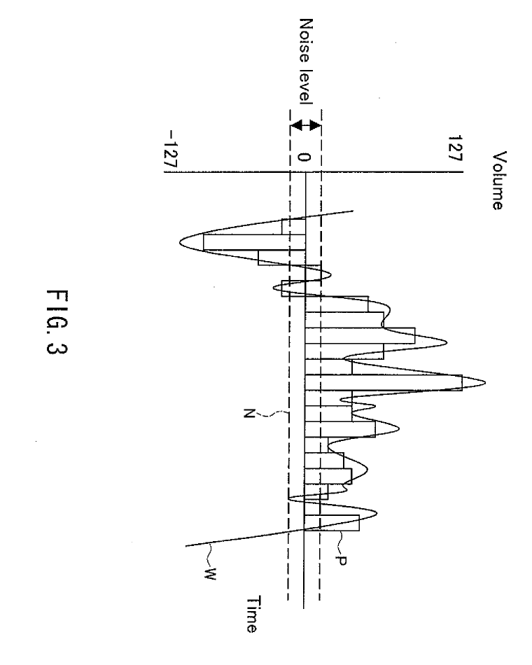

The uttering time measuring part 32a monitors the state of the input voice data, and measures a time when the transmitter of the telephone set 2 utters. Moreover, the uttering time measuring part 32a monitors the state of the output voice data, and measures a time when the receiver of the telephone set 3a utters. For example, the uttering time measuring part 32a judges the voice data having a volume of a noise level or higher as an uttering state, and measures the uttering time in the uttering state. FIG. 3 is a conceptional view showing an example of a voice waveform of the voice data and a state of sampling this voice waveform at each certain period of time. As shown in FIG. 3, the uttering time measuring part 32a monitors a packet P that is generated by sampling the voice waveform W of the voice data at each certain period of time, and judges whether a volume shown by the packet P is the noise level N or higher. The uttering time measuring part 32a judges as the uttering state in the case where the volume shown by the packet P is the noise level N or higher. On the other hand the uttering time measuring part 32a judges as a non-uttering state (silent state) in the case where the volume shown by the packet P is lower than the noise level N.

By the way, the above description provided the example where the uttering time measuring part 32a judges the voice data having the volume of the noise level N or higher as the uttering state, and measures the uttering time of the uttering state, but the present embodiment is not limited to this. For example, in the case where the telephone set 3a does not generate the packet P in the non-uttering state, the uttering time measuring part 32a may judge a period, in which sequence numbers showing the packet P are continuous, as the uttering state, and may judge a period in which the sequence numbers are not continuous as the non-uttering state. Moreover, for example, in the case where the telephone set 3a generates the packet P showing the uttering state or the non-uttering state, the uttering time measuring part 32a may judge a period of detecting the packet P that shows the uttering state as the uttering state, and may judge a period of detecting the packet P that shows the non-uttering state as the non-uttering state.

The uttering time measuring part 32a stores an uttering time of the transmitter and an uttering time of the receiver into the uttering time memory part 33. Incidentally, the uttering time measuring part 32a measures a communicating time from start to completion of the communication between the transmitter of the telephone set 2 and the receiver of the telephone set 3a, and stores the measured communicating time into the uttering time memory part 33.

When the communication between the transmitter and the receiver is completed, the uttering judging part 32b extracts the communicating time, the uttering time of the transmitter and the uttering time of the receiver that are stored in the uttering time memory part 33. The uttering judging part 32b judges whether the communicating time is shorter than a predetermined time or not, whether the transmitter utters one-sidedly or not, whether the transmitter is silent or not, and the like, based on the communicating time, the uttering time of the transmitter and the uttering time of the receiver that are extracted. Further, the uttering judging part 32b judges whether the communication is cut or not while the transmitter is uttering.

That is, in the case where the communicating time is shorter than the predetermined time, there is a high probability that the receiver judges the call as an unwanted call from the transmitter and cuts the communication immediately. Moreover, in the case where the communication is cut while the transmitter is uttering, there is a high probability that the receiver judges the call as an unwanted call from the transmitter and cuts the communication although the transmitter is uttering. Moreover, in the case where the transmitter utters one-sidedly, there is a high probability of one-side sales such as qualification sales and solicitation for forward trading by the transmitter is high. Further, in the case where the transmitter is silent, there is a high probability that the call is a prank call by the transmitter. That is, the uttering judging part 32b can judge such states as unwanted calls. Incidentally, the items to be judged by the uttering judging part 32b are not limited to these.

As an example, the uttering judging part 32b judges that the communication is completed in a short period of time in the case where the communication time is 15 seconds or less, for example. Moreover, in the case where the uttering judging part 32b detects that the user of the telephone set 3a operates, for example, a key provided on the handset 36 so as to cut the communication while the transmitter is uttering, the uttering judging part 32b judges to be in a state where the communication is cut while the transmitter is uttering. Moreover, in the case where the uttering time of the transmitter is, for example, 80% or more of the communicating time, the uttering judging part 32b judges to be in a state where the transmitter utters one-sidedly. Further, in the case where the uttering time of the transmitter is, for example, 5% or less of the communicating time, the uttering judging part 32b judges to be in a state where the transmitter does not utter substantially (silent state). It should be noted that the judgment standard of the uttering judging part 32b is not limited to these. The uttering judging part 32b outputs the judgment result to the evaluation item score data extracting part 40.

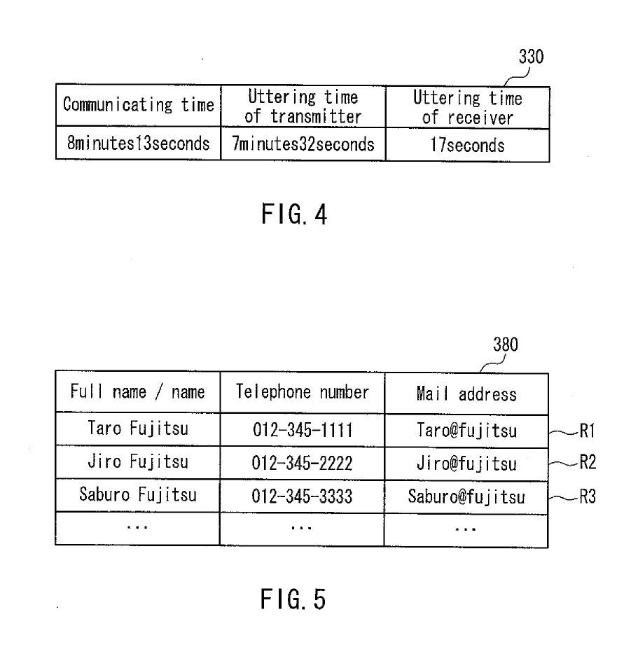

The uttering time memory part 33 stores the uttering time data showing the communication time, the uttering time of the transmitter and the uttering time of the receiver. Thus, the uttering time memory part 33 stores the uttering time data as an uttering time data table 330 shown in FIG. 4, for example. In the example shown in FIG. 4, in the uttering time data table 330, the communicating time of “8 minutes 13 seconds”, the uttering time of the transmitter of “7 minutes 32 seconds” and the uttering time of the receiver of “17 seconds” are stored. That is, since the uttering time of the transmitter of “7 minutes 32 seconds” is about 91.7% of the communicating time of “8 minutes 13 seconds”, the uttering judging part 32b judges to be in the state where the transmitter utters one-sidedly in the above-described example.

The data receiving part 34 is a buffer that accumulates the input voice data temporarily. Moreover, the data receiving part 34 has a function of changing a voice speed, a height of a tone of a voice and the like of the input voice data such that the receiver can hear the voice shown by the input voice data easily.

The data sending part 35 is a buffer that accumulates the output voice data temporarily. Moreover, the data sending part 35 has a function of removing echoes and noises included in the output voice data so as to improve sound quality of the output voice data. Further, the data sending part 35 has a function of compressing the output voice data so as to decrease a volume of the output voice data.

The handset 36 is transmitting/receiving equipment that is designed to combine receiving equipment 36a and transmitting equipment 36b so as to be held by one hand. The handset 36 has functions of voice data inputting and outputting, key inputting, lamp displaying, on-hook, off-hook, reproduction of transmitting/receiving rings and the like. The receiving equipment 36a is a reproducer that constructs a packet shown by the input voice data, generates an analog signal and reproduces the input voice data. The transmitting equipment 36b is a sender that generates a packet by sampling the analog signal that shows the uttering content of the receiver, and constructs the generated packet so as to generate the output voice data.

The receiving state monitoring part (monitoring part) 37 monitors a state of the call control data that is output from the line connecting interface part 31. Thus, the receiving state monitoring part 37 is provided with a telephone directory searching part 37a and a single-ring-and-hang-up call judging part 37b.

The telephone directory searching part 37a extracts a telephone number of the telephone set 2 included in the call control data, and judges whether the extracted telephone number of the telephone set 2 is stored in the telephone directory data memory part 38 or not. More specifically, the telephone directory searching part 37a uses the extracted telephone number of the telephone set 2 as a searching key, and judges whether this telephone number as the searching key is stored in the telephone directory data memory part 38 or not. The telephone directory searching part 37a outputs a judgment result to the evaluation item score data extracting part 40. Moreover, the telephone directory searching part 37a outputs the extracted telephone number of the telephone set 2 to the sending part 42.

Moreover, in the case where the call control data includes data showing no notification instead of the telephone number of the telephone set 2, the telephone directory searching part 37a judges that the telephone number of the telephone set 2 is not stored in the telephone directory data memory part 38 without searching the telephone directory data memory part 38. In such a case, the telephone directory searching part 37a extracts a call identifier that is included in the call control data. The telephone directory searching part 37a outputs the extracted call identifier to the sending part 42.

The single-ring-and-hang-up call judging part (call judging part) 37b judges whether the call control data shows the establishment of the calls of the telephone sets 2 and 3a or not. That is, the single-ring-and-hang-up call judging part 37b judges whether the transmission of the telephone set 2 is a so-called single-ring-and-hang-up call or not. For example, the single-ring-and-hang-up call judging part 37b monitors a calling message included in the call control data, and judges that this transmission is a single-ring-and-hang-up call in the case where this calling message shows only one or two rings. The single-ring-and-hang-up call judging part 37b outputs a judgment result to the evaluation item score data extracting part 40. It should be noted that the single-ring-and-hang-up call is a kind of an unwanted call that utilizes a reception history displaying function of the telephone set, for example, a call that is hung up after one or two rings so as to generate an imperfect call (transmission without communication) deliberately.

By the way, the above description provided the example in which the single-ring-and-hang-up call judging part 37b judges as a single-ring-and-hang-up call in the case where the calling message shows only one or two rings, but the present embodiment is not limited to this. For example, the single-ring- and-hang-up call judging part 37b may judge as the single-ring-and-hang-up call in the case where the calling message shows a call of only one second or two seconds. That is, a judging method is arbitrary as long as the single-ring-and-hang-up call judging part 37b can judge as the single-ring-and-hang-up call or not.

The telephone directory data memory part 38 stores telephone directory data showing telephone numbers that correspond to full names or names. Thus, the telephone directory data memory part 38 stores the telephone directory data as a telephone directory data table 380 as shown in FIG. 5, for example. In the example shown in FIG. 5, in line 1, R1 of the telephone directory data table 380, a full name of “Taro Fujitsu”, a telephone number of “012-345-1111” and a mail address of “Taro@fujitsu” are stored. In line 2, R2, a full name of “Jiro Fujitsu”, a telephone number of “012-345-2222” and a mail address of “Jiro@fujitsu” are stored. In line 3, R3, a full name of “Saburo Fujitsu”, a telephone number of “012-345-3333” and a mail address of “Saburo@fujitsu” are stored. Incidentally the telephone directory data memory part 38 may store telephone directory data showing zip codes, addresses or the like besides the full names, the telephone numbers and the mail addresses.

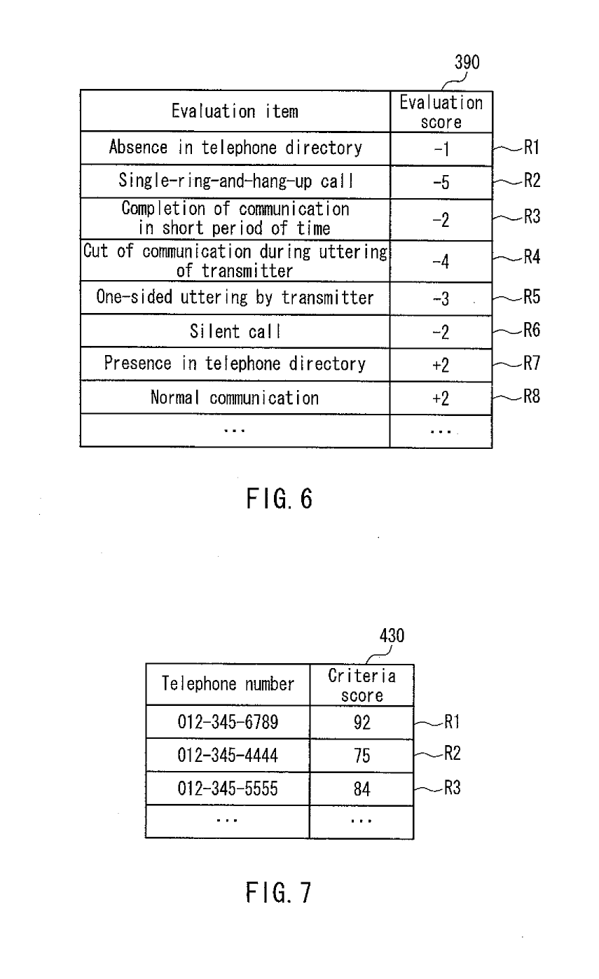

The evaluation data memory part 39 stores evaluation item data showing an evaluation item of the transmitting data and evaluation item score data showing an evaluation score of this evaluation item. Thus, the evaluation data memory part 39 stores the evaluation item data and the evaluation item score data as an evaluation data table 390 as shown in FIG. 6, for example. In the example shown in FIG. 6, in line 1, R1 of the evaluation data table 390, an evaluation item of “absence in telephone directory” and an evaluation score of “−1” are stored. In line 2, R2, an evaluation item of “single-ring-and-hang-up call” and an evaluation score of “−5” are stored. In line 3, R3, an evaluation item of “completion of communication in short period of time” and an evaluation score of “−2” are stored. In line 4, R4, an evaluation item of “cut of communication during uttering of transmitter” and an evaluation score of “−4” are stored. Moreover, in line 5, R5, an evaluation item of “one-sided uttering by transmitter” and an evaluation score of “−3” are stored. Moreover, in line 6, R6, an evaluation item of “silent call” and an evaluation score of “−2” are stored. Moreover, in line 7, R7, an evaluation item of “presence in telephone directory” and an evaluation score of “+2” are stored. Further, in line 8, R8, an evaluation item of “normal communication” and an evaluation score of “+2” are stored.

The above description provided the example where the uttering time memory part 33, the telephone directory data memory part 38 and the evaluation data memory part 39 stores the respective data in a table form, but the present embodiment is not limited to this. That is, the storing form is arbitrary.

The evaluation item score data extracting part (extracting part) 40 extracts the evaluation item score data stored in the evaluation data memory part 39 based on a monitoring (judgment) result that is output from the communicating state monitoring part 32 and the receiving state monitoring part 37. The evaluation item score data extracting part 40 outputs the extracted evaluation item score data to the transmitting terminal evaluating part 41.

As an example, in a case where the a state that only the transmitter utters one-sidedly is shown as the monitoring result of the communicating state monitoring part 32, the evaluation item score data extracting part 40 extracts the evaluation item score data of “−3” that corresponds to the evaluation item of “one-sided uttering by transmitter” from the evaluation data memory part 39. Moreover, in the case where a state that the telephone number of the telephone set 2 is not stored in the telephone directory data memory part 38 is shown as the monitoring result of the receiving state monitoring part 37, the evaluation item score data extracting part 40 extracts the evaluation item score data of “−1” that corresponds to the evaluation item of “absence in telephone directory” from the evaluation data memory part 39. The evaluation item score data extracting part 40 outputs the extracted evaluation item score data of “−3” and “−1” to the transmitting terminal evaluating part 41.

Moreover, as another example, in the case where the monitoring result of the communicating state monitoring part 32 includes no subtraction (negative score) of the evaluation score of the evaluation items shown by the evaluation item score data, and the monitoring result of the receiving state monitoring part 37 shows a state that is not the single-ring-and-hang-up call, the evaluation item score data extracting part 40 extracts the evaluation item score data of “+2” that corresponds to the evaluation item of “normal communication” from the evaluation data memory part 39. Moreover, in the case where the monitoring result of the receiving state monitoring part 37 shows a state that the telephone number of the telephone set 2 is stored in the telephone directory data memory part 38, the evaluation item score data extracting part 40 extracts the evaluation item score data of “+2” that corresponds to the evaluation item of “presence in telephone directory” from the evaluation data memory part 39. The evaluation item score data extracting part 40 outputs the extracted evaluation item score data of “+2” and “+2” to the transmitting terminal evaluating part 41.

The transmitting terminal evaluating part 41 calculates the evaluation score of the telephone set 2 serving as the transmitting terminal, based on the evaluation item score data extracted by the evaluation item score data extracting part 39. As an example, in the case where the evaluation item score data extracting part 39 extracts the evaluation item score data of “−3” and “−1”, the transmitting terminal evaluating part 41 adds “−3” and “−1” so as to obtain “−4” as the evaluation score of the telephone set 2. As another example, in the case where the evaluation item score data extracting part 39 extracts the evaluation item score data of “+2” and “+2”, the transmitting terminal evaluating part 41 adds “+2” and “+2” so as to obtain “+4” as the evaluation score of the telephone set 2. The transmitting terminal evaluating part 41 outputs the calculated evaluation score of the telephone set 2 to the sending part 42.

The sending part 42 sends the telephone number of the telephone set 2 extracted by the telephone directory searching part 37a and the evaluation score of the telephone set 2 calculated by the transmitting terminal evaluating part 41 to the criteria score data memory apparatus 4 via the IP telephone network N. Incidentally, in the case where the telephone directory searching part 37a extracts the call identifier from the call control data, the sending part 42 sends this call identifier, the evaluation score of the telephone set 2 calculated by the transmitting terminal evaluating part 41 to the criteria score data memory apparatus 4 via the IP telephone network N.

As an example, in the case where the transmitting terminal evaluating part 41 obtains “−4” as the evaluation score of the telephone set 2, the sending part 42 adds the evaluation score of the telephone set 2 of “−4” to the telephone number or the identifier of the telephone set 2, and sends them to the criteria score data memory apparatus 4 via the IP telephone network N. Moreover, as another example, in the case where the transmitting terminal evaluating part 41 obtains “+4” as the evaluation score of the telephone set 2, the sending part 42 adds the evaluation score of the telephone set 2 of “+4” to the telephone number or the identifier of the telephone set 2, and sends them to the criteria score data memory apparatus 4 via the IP telephone network N.

By the way, the above-described telephone set 3a can be realized also by installing a program into an arbitrary computer such as a personal computer. That is, the line connecting interface part 31, the communicating state monitoring part 32, the data receiving part 34, the data sending part 35, the handset 36, the receiving state monitoring part 37, the evaluation item score data extracting part 40, the transmitting terminal evaluating part 41 and the sending part 42 that are described above are realized by operating according to the program that enables a CPU of the computer to realize these functions. Thus, the program for realizing the functions of the line connecting interface part 31, the communicating state monitoring part 32, the data receiving part 34, the data sending part 35, the handset 36, the receiving state monitoring part 37, the evaluation item score data extracting part 40, the transmitting terminal evaluating part 41 and the sending part 42 or a recording medium that stores the program are also included in one embodiment of the present invention. Moreover, the uttering time memory part 33, the telephone directory data memory part 38 and the evaluation data memory part 39 are realized by an internal memory apparatus of the computer or a memory apparatus that can be accessed from this computer.

(Structure of Criteria Score Data Memory Apparatus)

As shown in FIG. 1, a criteria score data memory apparatus (criteria value data memory apparatus) 4 is provided with a criteria score data memory part 43, a criteria score data updating part 44 and a communication processing part 45. The criteria score data memory apparatus 4 is structured on one or a plurality of the computers such as a server machine, a personal computer, a work station or the like.

The criteria score data memory part (criteria value data memory part) 43 stores the criteria score data showing the criteria score of the transmitting terminal serving as a criteria that controls the calls of the transmitting terminal and the receiving terminal. Thus, the criteria score data memory part 43 stores the criteria score data as a criteria score data table 430 as shown in FIG. 7, for example. In the example shown in FIG. 7, in line 1, R1 of the criteria score data table 430, a telephone number of a telephone set of “012-345-6789” and a criteria score of “92” are stored. In line 2, R2, a telephone number of a telephone set of “012-345-4444” and a criteria score of “75” are stored. In line 3, R3, a telephone number of a telephone set of “012-345-5555” and a criteria score of “84” are stored. Incidentally, the above description provided the example in which the criteria score data memory part 43 stores the criteria score data in a table form, but the present embodiment is not limited to this, and the storing form is arbitrary. Moreover, the above description provided the example in which the numbers (scores) are stored as the criteria score data, but the present embodiment is not limited to this, and for example, rank values such as a rank A, B, C or the like may be stored. Moreover, an upper limit of the criteria score may be larger than 100 scores, and is arbitrary. Further, a lower limit of the criteria score may be smaller than 0 score, and is arbitrary.

The criteria score data updating part (updating part) 44 receives the telephone number and the evaluation score of the telephone set 2 from the sending part 42 of the telephone set 3a. The criteria score data updating part 44 updates the criteria score data of the telephone set 2 that is stored in the criteria score data memory part 43 according to the telephone number and the evaluation score of the telephone set 2. Moreover, in the case of receiving the call identifier and the evaluation score of the telephone set 2 from the sending part 42, the criteria score data updating part 44 outputs this identifier to the communication processing part 45, and requests the communication processing part 45 to obtain the telephone number of the telephone set 2 from the call control server 5. When the communication processing part 45 obtains the telephone number of the telephone set 2 from the call control server 5, the criteria score data updating part 44 updates the criteria score data of the telephone set 2 stored in the criteria score data memory part 43, based on the telephone number and the evaluation score of the telephone set 2. Thereby even in the case where the call control data received by the line connecting interface part 31 includes data showing no notification, the criteria score data updating part 44 can update the criteria score data of the telephone set 2 stored in the criteria score data memory part 43, based on the telephone number and the evaluation score of the telephone set 2.

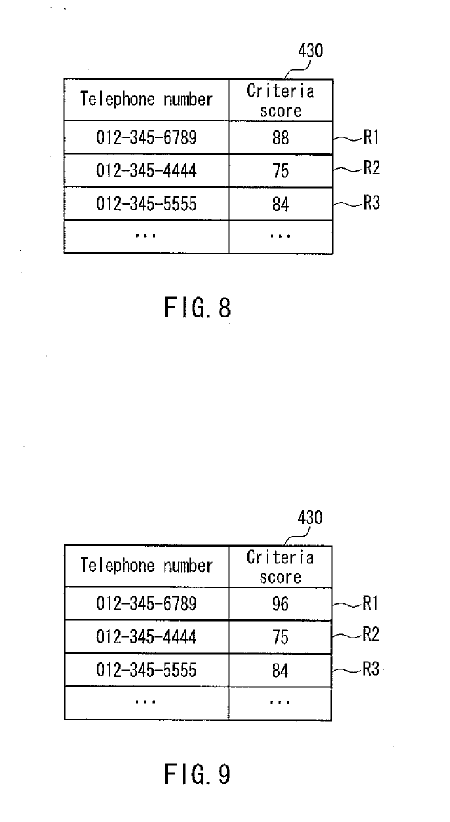

As an example, it is assumed that the criteria score data updating part 44 receives the telephone number of the telephone set 2 of “012-345-6789” and the evaluation score of the telephone set 2 of “−4”. The criteria score data updating part 44 extracts the criteria score data of the telephone set 2 of “92” that is stored in the criteria score data memory part 43, based on the telephone number of the telephone set 2 of “012-345-6789”. The criteria score data updating part 44 adds the evaluation score of the telephone set 2 of “−4” to the extracted criteria score data of the telephone set 2 of “92”. When the evaluation score of the telephone set 2 of “−4” is added to the criteria score data of the telephone set 2 of “92”, the criteria score data of the telephone set 2 is decreased to “88”. The criteria score data updating part 44 stores the criteria score data of the telephone set 2 of “88” into the criteria score data memory part 43. That is, the criteria score data of the telephone set 2 of “92” stored in the criteria score data memory part 43 is updated to the criteria score data of “88” as shown in FIG. 8.

Further, as another example, it is assumed that the criteria score data updating part 44 receives the telephone number of the telephone set 2 of “012-345-6789” and the evaluation score of the telephone set 2 of “+4”. The criteria score data updating part 44 extracts the criteria score data of the telephone set 2 of “92” that is stored in the criteria score data memory part 43, based on the telephone number of the telephone set 2 of “012-345-6789”. The criteria score data updating part 44 adds the evaluation score of the telephone set 2 of “+4” to the extracted criteria score data of the telephone set 2 of “92”. When the evaluation score of the telephone set 2 of “+4” is added to the criteria score data of the telephone set 2 of “92”, the criteria score data of the telephone set 2 is increased to “96”. The criteria score data updating part 44 stores the criteria score data of the telephone set 2 of “96” into the criteria score data memory part 43. That is, the criteria score data of the telephone set 2 of “92” that is stored in the criteria score data memory part 43 is updated to the criteria score data of “96” as shown in FIG. 9.

Incidentally, the above description provided the example in which the telephone directory searching part 37a extracts the telephone number or the call identifier of the telephone set 2 included in the call control data, and the criteria score data updating part 44 updates the criteria score data of the telephone set 2 stored in the criteria score data memory part 43, but the present embodiment is not limited to this. That is, it is also possible that the telephone directory searching part 37a extracts a telephone number of itself (a telephone number of the telephone set 3a) from the memory part (not illustrated), and the criteria score data updating part 44 updates the criteria score data of the telephone set 2 stored in the criteria score data memory part 43. More specifically, the call control server 5 records a transmitting/receiving log between the telephone set 2 as the transmitting terminal and the telephone set 3a as the receiving terminal. The communication processing part 45 requests a below-described request receiving part 57 of the call control server 5 to obtain the telephone number of the telephone set 2 from the telephone number of the telephone set 3a, based on the recorded transmitting/receiving log. The communication processing part 45 obtains the telephone number of the telephone set 2 from the request receiving part 57 of the call control server 5. Thereby, the criteria score data updating part 44 can update the criteria score data of the telephone set 2 that is stored in the criteria score data memory part 43.

The communication processing part 45 extracts the criteria score data of the telephone set 2 that is stored in the criteria score data memory part 43 according to the request from a below-described criteria score data obtaining part 53 of the call control server 5. The communication processing part 45 sends the extracted criteria score data of the telephone set 2 to the criteria score data obtaining part 53 of the call control server 5 via the IP telephone network N. Incidentally in the case where the criteria score data memory apparatus 4 and the call control server 5 are connected to each other via an Ethernet (registered trademark), the criteria score data of the telephone set 2 may be sent via this Ethernet (registered trademark).

Moreover, the communication processing part 45 accesses the request receiving part 57 of the call control server 5 according to the request from the criteria score data updating part 44 so as to obtain the telephone number of the telephone set 2 stored in the call control server 5. The communication processing part 45 outputs the obtained telephone number of the telephone set 2 to the criteria score data updating part 44.

By the way, the above-described criteria score data memory apparatus 4 is also realized by installing the program into an arbitrary computer such as a personal computer. That is, the criteria score data updating part 44 and the communication processing part 45 described above are realized by an operation of a CPU of the computer according to the program that realizes these functions. Thus, the program that realizes the functions of the criteria score data updating part 44 and the communication processing part 45, or a recording medium that stores the program are also included in one embodiment of the present invention. Moreover, the criteria score data memory part 43 is realized by the internal memory part of the computer or a memory apparatus that can be accessed from this computer.

(Structure of Call Control Server)

As shown in FIG. 1, the call control server 5 is provided with a call processing part 51, a communication controlling part 52, a criteria score data obtaining part 53, a user data memory part 54, a transmission penalty memory part 55, a corresponding data memory part 56, a request receiving part 57 and a time measuring part 58. The call control server 5 is structured on one or a plurality of computers such as a server machine, a personal computer, a work station and the like. Incidentally, the call control server 5 has a congestion controlling function that monitors a total volume of communication traffic in the IP telephone network N, and controls a newly transmitted communication, when the communication is congested more than a certain level.

The call processing part 51 is an interface part that can receive the call control data including the calling message from the telephone set 2. The call processing part 51 outputs the received call control data to the communication controlling part 52. Moreover, the call processing part 51 is an interface part that can accept the call control data including the calling message from the communication controlling part 52. The call processing part 51 sends the accepted call control data to the telephone set 3a via the IP telephone network N.

The communication controlling part 52 controls the calls of the telephone set 2 serving as the transmitting terminal and the telephone set 3a serving as the receiving terminal. Incidentally, the detailed description of the communication controlling part 52 will be provided below.

The criteria score data obtaining part 53 accesses the communication processing part 45 of the criteria score data memory apparatus 4 according to the request from the communication controlling part 52, and obtains the criteria score data of the telephone set 2 that is stored in the criteria score data memory part 43. The criteria score data obtaining part 53 outputs the obtained criteria score data of the telephone set 2 to the communication controlling part 52.

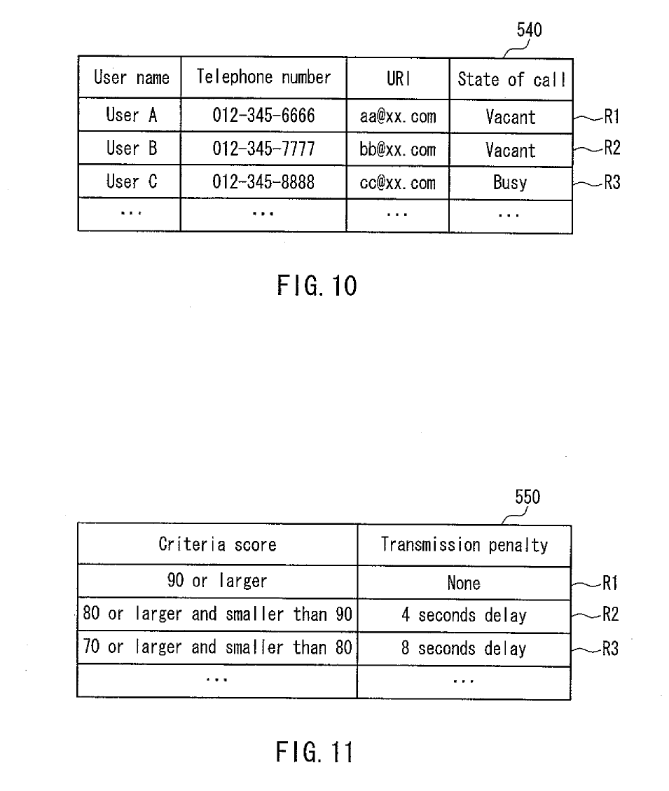

The user data memory part 54 stores user data showing a user name, a telephone number, an URI (Uniform Resource Identifier) and a state of a call. Thus, the user data memory part 54 stores the user data as a user data table 540 as shown in FIG. 10, for example. In the example shown in FIG. 10, in line 1, R1 of the user data table 540, a user name of “User A”, a telephone number of “012-345-6666”, a URL of “aa@xx.com” and a state of a call of “vacant” are stored. In line 2, R2, a user name of “User B”, a telephone number of “012-345-7777”, a URL of “bb@xx.com” and a state of a call of “vacant” are stored. In line 3, R3, a user name of “User C”, a telephone number of “012-345-8888”, a URL of “cc@xx.com” and a state of a call of “busy” are stored.

The transmission penalty memory part 55 stores stepwise a delay time of the call control data shown by the transmission penalty data that delays the call control data sent by the transmitting terminal, according to each step of the criteria score of the transmitting terminal provided in a plurality of the steps. Thus, the transmission penalty memory part 55 stores the transmission penalty data as a transmission penalty data table 550 as shown in FIG. 11, for example. In the example shown in FIG. 11, in line 1, R1 of the transmission penalty data table 550, a criteria score of “90 or larger” and a transmission penalty of “none” are stored. In line 2, R2, a criteria score of “80 or larger and smaller than 90” and a transmission penalty of “4 seconds delay” are stored. In line 3, R3, a criteria score of “70 or larger and smaller than 80” and a transmission penalty of “8 seconds delay” are stored.

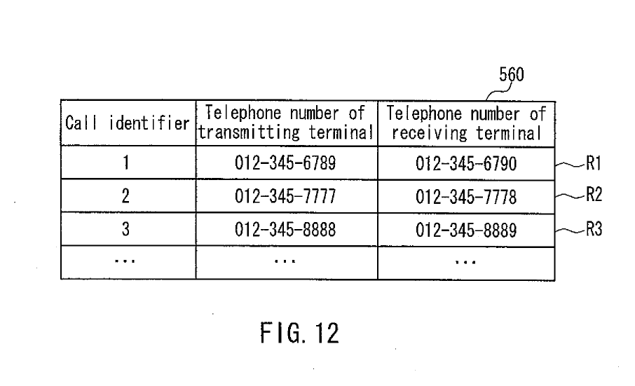

The corresponding data memory part 56 stores the corresponding data showing the call identifier, the telephone number of the transmitting terminal and the telephone number of the receiving terminal. Thus, the corresponding data memory part 56 stores the corresponding data as the corresponding data table 560 as shown in FIG. 12, for example. In the example shown in FIG. 12, in line 1, R1 of the corresponding data table 560, an identifier of “1”, a telephone number of the transmitting terminal of “012-345-6789” and a telephone number of a receiving terminal of “012-345-6790” are stored. In line 2, R2, an identifier of “2”, a telephone number of a transmitting terminal of “012-345-7777” and a telephone number of a receiving terminal of “012-345-7778” are stored. In line 3, R3, an identifier of “3”, a telephone number of a transmitting terminal of “012-345-8888” and a telephone number of the receiving terminal of “012-345-8889” are stored.

Incidentally, the above description provided the example in which the user data memory part 54, the transmission penalty memory part 55 and the corresponding data memory part 56 stores the respective data in a table form, but the present embodiment is not limited to this. That is, the storing form is arbitrary.

The request receiving part 57 is an interface part that can receive an access from the communication processing part 45 of the criteria score data memory apparatus 4. In the case where the access from the communication processing part 45 shows the obtaining of the telephone number of the telephone set 2, the request receiving part 57 extracts the telephone number of the telephone set 2 serving as the transmitting terminal that is stored in the corresponding data memory part 56, based on the call identifier. For example, in the case where the call identifier is “1”, the request receiving part 57 extracts the telephone number “012-345-6789” of the telephone set 2 serving as the transmitting terminal, which is stored in the corresponding data memory part 56. The request receiving part 57 sends the extracted telephone number of the telephone set 2 to the communication processing part 45.

The time measuring part 58 is constituted of, for example, a timer, a counter and the like, and has a function of measuring a predetermined time.

The communication controlling part 52 extracts the call identifier that is included in the call control data output from the call processing part 51, the telephone number of the telephone set 2 serving as the transmitting terminal and the telephone number of the telephone set 3a serving as the receiving terminal. The communication controlling part 52 extracts the URI of the telephone set 3a that is stored in the user data memory part 54, based on the extracted telephone number of the telephone set 3a. The communication controlling part 52, for example, accesses a DNS server (not illustrated) based on the extracted URI of the telephone set 3a, and obtains an IP address of the telephone set 3a. Moreover, the communication controlling part 52 refers to the state of the call of the telephone set 3a that is stored in the user data memory part 54, and outputs the call control data including the calling message to the call processing part 51, if the state of the call of the telephone set 3a is “vacant”. Whereas, if the state of the call of the telephone set 3a is “busy”, the communication controlling part 52 outputs the call control data including the busy message to the call processing part 51. In this case, the call processing part 51 sends this call control data to the telephone set 2.

Moreover, the communication controlling part 52 stores the extracted call identifier, the telephone number of the telephone set 2 serving as the transmitting terminal and the telephone number of the telephone set 3a serving as the receiving terminal into the corresponding data memory part 56.

Further, the communication controlling part 52 is provided with a transmission delay processing part 52a. The transmission delay processing part 52a extracts the transmission penalty data stored in the transmission penalty memory part 55, based on the criteria score of the telephone set 2, and performs processing to maintain the call control data that is sent by the telephone set 2, based on the delay time of the call control data shown by the transmission penalty data.

As an example, it is assumed that the call processing part 51 receives the call control data sent from the telephone set 2, and outputs the received call control data to the communication controlling part 52. Also, it is assumed that the criteria score data obtaining part 53 obtains the criteria score data of the telephone set 2 of “88”. In such a case, the transmission delay processing part 52a extracts the transmission penalty data of “4 seconds delay” that is stored in the transmission penalty memory part 55, based on the criteria score data of the telephone set 2 of “88”. The transmission delay processing part 52a instructs the time measuring part 58 to measure “4 seconds” based on the extracted transmission penalty data of “4 seconds delay”. The transmission delay processing part 52a maintains the call control data that is output from the call processing part 51 until the completion of the measurement of “4 seconds” by the time measuring part 58. After the completion of the measurement of “4 seconds” by the time measuring part 58, the transmission delay processing part 52a outputs the call control data to the call processing part 51. The call processing part 51 sends the call control data to the telephone set 3a. Thereby the transmission from the telephone set 2 to the telephone set 3a is delayed by 4 seconds.

As another example, it is assumed that the call control data sent from the telephone set 2 is received, and the received call control data is output to the communication controlling part 52. Also, it is assumed that the criteria score data obtaining part 53 obtains the criteria score data of the telephone set 2 of “96”. In such a case, the transmission delay processing part 52a extracts the transmission penalty data of “none” that is stored in the transmission penalty memory part 55, based on the criteria score data of the telephone set 2 of “96”. Since the transmission penalty data shows “none”, the transmission delay processing part 52a outputs the call control data to the call processing part 51 without maintaining the call control data that is output from the call processing part 51. The call processing part 51 sends the call control data to the telephone set 3a. Thereby, the transmission from the telephone set 2 to the telephone set 3a is not delayed.

By the way, the above-described call control server 5 is achieved also by installing the program into an arbitrary computer such as a personal computer. That is, the call processing part 51, the communication controlling part 52, the criteria score data obtaining part 53, the request receiving part 57 and the time measuring part 58 described above are realized by an operation of the CPU of the computer according to the program that realizes these functions. Thus, a program that realizes the functions of the call processing part 51, the communication controlling part 52, the criteria score data obtaining part 53, the request receiving part 57 and the time measuring part 58 or a recording medium that stores the program is also included in one embodiment of the present invention. Moreover, the user data memory part 54, the transmission penalty memory part 55 and the corresponding data memory part 56 are realized by an internal memory apparatus of this computer or a memory apparatus that can be accessed from this computer.

The above description provided the structure of the call control system 1, but the structure of the call control system 1 is not limited to the structure shown in FIG. 1. For example, the criteria score data memory apparatus 4 in the call control system 1 can also be provided in the call control server 5 as one function of the call control server 5.

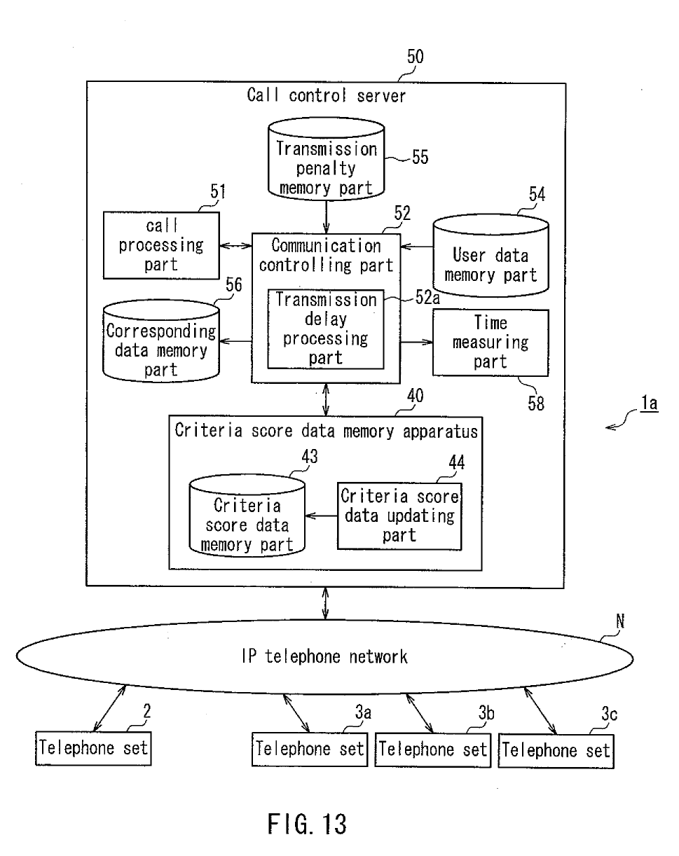

FIG. 13 is a block diagram showing a schematic structure of a call control system 1a in a case of providing the criteria score data memory apparatus in the call control server. In FIG. 13, the structures having the same functions as those in FIG. 1 are denoted by the same reference numerals. Since the criteria score data memory apparatus 40 is provided in the call control server 50, the communication processing part 45 in the criteria score data memory apparatus 4, and the criteria score data obtaining part 53 and the request receiving part 57 in the call control server 5, which are shown in FIG. 1, are not necessary.

(Operational Example of Receiving Terminal)

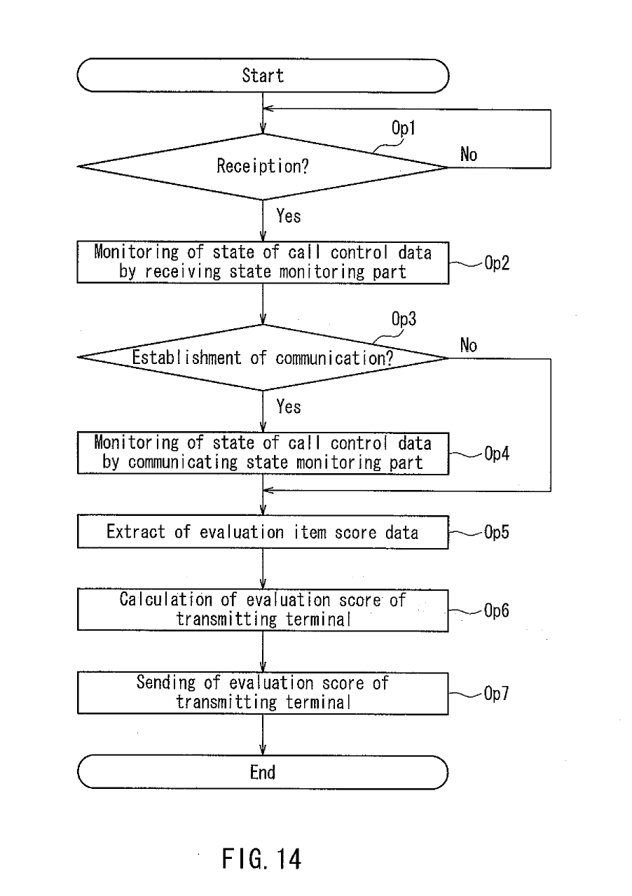

Next, processing of the telephone set 3a in the call control system 1 according to the above-described structure will be described below with reference to FIG. 14.

FIG. 14 is a flow chart schematically showing processing of the telephone set 3a. That is, as shown in FIG. 14, the line connecting interface part 31 receives call control data including a calling message sent from the telephone set 2, whereby the receiving state monitoring part 37 monitors a state of the call control data output from the line connecting interface part 31 (Op 2), when there is a reception (calling) from the telephone set 2 (Yes in Op 1). The receiving state monitoring part 37 monitors whether the telephone number of the telephone set 2 is stored in the telephone directory memory part 38 or not, whether the reception from the telephone set 2 is a single-ring-and-hang-up call or not, and the like. On the other hand, there is no reception from the telephone set 2 (No in Op 1), the operation returns to Op 1.

When the user of the telephone set 3a operates, for example, a key provided on the handset 36 during the reception from the telephone set 2, if a communication (call) with the telephone set 2 is established (Yes in Op 3), the communicating state monitoring part 32 monitors states of input voice data that is output from the line connecting interface part 31 and output voice data that is output from the data sending part 35 (Op 4). The communicating state monitoring part 32 monitors whether a communicating time is shorter than a predetermined time or not, whether the communication is cut while the transmitter is uttering or not, whether the transmitter utters one-sidedly or not, whether the transmitter is silent or not, and the like. On the other hand, if the communication (call) with the telephone set 2 is not established (No in Op 3), the operation proceeds to Op 5.

The evaluation item score data extracting part 40 extracts the evaluation item score data that is stored in the evaluation data memory part 39, based on the monitoring (judging) result output from the communicating state monitoring part 32 and the receiving state monitoring part 37 (Op 5). Incidentally, a timing when the evaluation item score data extracting part 40 extracts the evaluation item score data is after the reception from the telephone set 2 or the cutting of the communication with the telephone set 2, but is not limited to these.

The transmitting terminal evaluating part 41 calculates an evaluation score of the telephone set 2 serving as the transmitting terminal, based on the evaluation item score data that is extracted by the evaluation item score data extracting part 39 (Op 6). The sending part 42 sends the telephone number or the call identifier of the telephone set 2 that are extracted by the telephone directory searching part 37a and the evaluation score of the telephone set 2 that is calculated by the transmitting terminal evaluating part 41 to the criteria score data memory apparatus 4 via the IP telephone network N (Op 7). Also, the telephone sets 3b and 3c also perform the same processing as Op 1 to Op 7.

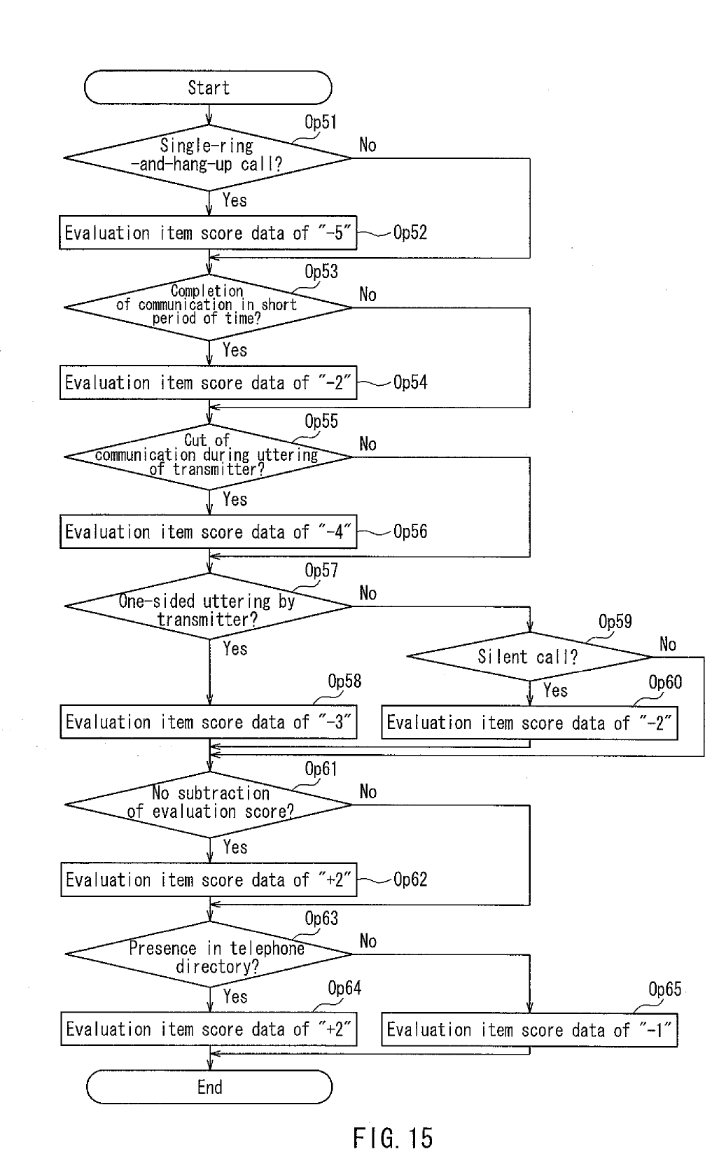

Herein, an example of the processing of the evaluation item score data extracting part 40 in Op 5 will be described with reference to FIG. 15.

FIG. 15 is a flow chart showing an example of processing of the evaluation item score data extracting part 40. As shown in FIG. 15, if the single-ring-and-hang-up call judging part 37b judges that the reception from the telephone set 2 is a single-ring-and-hang-up call (Yes in Op 51), the evaluation item score data extracting part 40 extracts the evaluation item score data of “−5” that corresponds to the evaluation item of the “single-ring-and-hang-up call” from the evaluation data memory part 39 (Op 52). On the other hand, unless the single-ring-and-hang-up call judging part 37b judges that the reception from the telephone set 2 is a single-ring-and-hang-up call (No in Op 51), the operation proceeds to Op 53.

Next, if the utter judging part 32b judges that the communicating time is shorter than the predetermined time (Yes in Op 53), the evaluation item score data extracting part 40 extracts the evaluation item score data of “−2” that corresponds to the evaluation item of the “completion of communication in short period of time” from the evaluation data memory part 39 (Op 54). On the other hand, unless the uttering judging part 32b judges that the communicating time is shorter than the predetermined time (No in Op 53), the operation proceeds to Op 55.

Next, the uttering judging part 32b judges that the communication is cut while the transmitter is uttering (Yes in Op 55), the evaluation item score data extracting part 40 extracts the evaluation item score data of “−4” that corresponds to the evaluation item of the “cut of communication during uttering of transmitter” from the evaluation data memory part 39 (Op 56). On the other hand, unless the uttering judging part 32b judges that the communication is cut while the transmitter is uttering (No in Op 55), the operation proceeds to Op 57.

Next, if the uttering judging part 32b judges that the transmitter utters one-sidedly (Yes in Op 57), the evaluation item score data extracting part 40 extracts the evaluation item score data of “−3” that corresponds to the evaluation item of the “one-sided uttering by transmitter” from the evaluation data memory part 39 (Op 58). On the other hand, unless the uttering judging part 32b judges that the transmitter utters one-sidedly (No in Op 57), the operation proceeds to Op 59, and the uttering judging part 32b judges whether the transmitter does not utter substantially (a silent state) or not. Then, the uttering judging part 32b judges as a so-called silent call (Yes in Op 59), the evaluation item score data extracting part 40 extracts the evaluation item score data of “−2” that corresponds to the evaluation item of the “silent call” from the evaluation data memory part 39 (Op 60). On the other hand, unless the uttering judging part 32b judges as a silent call (No in Op 59), the operation proceeds to Op 61.

Herein, in the case where there is no subtraction (negative score) in the evaluation scores of the evaluation items shown by the evaluation item score data in Ops 51, 53, 55, 57 and 59, that is, in the case of No in Ops 51, 53, 55, 57 and 59 (Yes in Op 61), the evaluation item score data extracting part 40 extracts the evaluation item score data of “+2” that corresponds to the evaluation item of the “normal communication” from the evaluation data memory part 39 (Op 62). On the other hand, in the case where there is a subtraction in the evaluation scores of the evaluation items shown by the evaluation item score data in Ops 51, 53, 55, 57 and 59, that is, in the case of Yes in at least one of Ops 51, 53, 55, 57 and 59 (No in Op 61), the operation proceeds to Op 63.

Next, if the telephone directory searching part 37a judges that the telephone number of the telephone set 2 is stored in the telephone directory data memory part 38 (Yes in Op 63), the evaluation item score data extracting part 40 extracts the evaluation item score data of “+2” that corresponds to the evaluation item of the “presence in telephone directory” from the evaluation data memory part 39 (Op 64). On the other hand, unless the telephone directory searching part 37a judges that the telephone number of the telephone set 2 is stored in the telephone directory data memory part 38 (No in Op 63), the evaluation item score data extracting part 40 extracts the evaluation item score data of “−1” that corresponds to the evaluation item of the “absence in telephone directory” from the evaluation data memory part 39 (Op 65).

(Operational Example of Criteria Score Data Memory Apparatus)

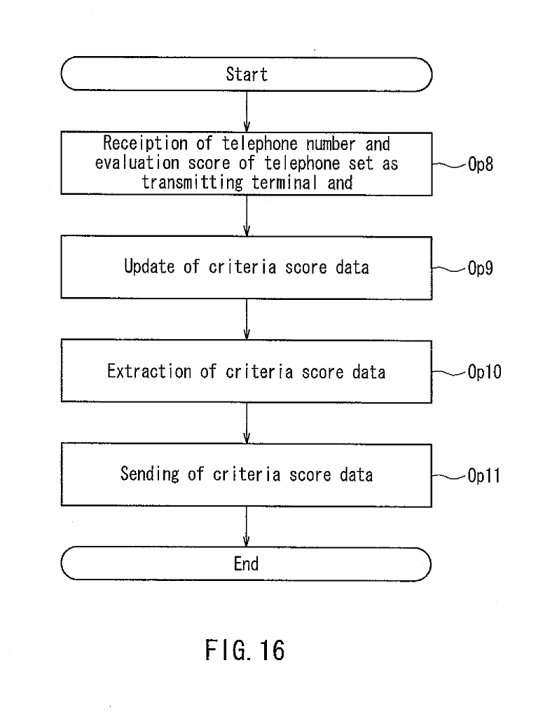

Next, processing of the criteria score data memory apparatus 4 in the call control system 1 according to the above-described structure will be described with reference to FIG. 16.

FIG. 16 is a flow chart showing an example of the processing of the criteria score data memory apparatus 4. As shown in FIG. 16, the criteria score data updating part 44 receives the telephone number and the evaluation score of the telephone set 2 that are sent in Op 7 of FIG. 14 (Op 8). The criteria score data updating part 44 updates the criteria score data of the telephone set 2 that is stored in the criteria score data memory part 43, based on the telephone number and the evaluation score of the telephone set 2 (Op 9).

Thereafter, when the communication processing part 45 receives the request to extract the criteria score data of the telephone set 2 from the criteria score data obtaining part 53 of the call control server 5, the communication processing part 45 extracts the criteria score data that is stored in the criteria score data memory part 43, based on the telephone number of the telephone set 2 (Op 10). The communication processing part 45 sends the extracted criteria score data to the criteria score data obtaining part 53 of the call control server 5 (Op ii).

Incidentally, in the present embodiment, the transmitter of the unwanted calls transmits the unwanted calls to the telephone sets 3a, 3b and 3c in this order by using the telephone set 2. Thus, the criteria score data updating part 44 repeats the above-described Ops 8 and 9 with respect to the telephone sets 3a, 3b and 3c in this order.

For example, it is assumed that the criteria score data updating part 44 receives the evaluation score of the telephone set 2 of “−4” from the telephone set 3a. Moreover, it is also assumed that the criteria score data updating part 44 receives the evaluation score of the telephone set 2 of “−6” from the telephone set 3b. Further, it is assumed that the criteria score data updating part 44 receives the evaluation score of the telephone set 2 of “−2” from the telephone set 3c. In addition, it is assumed that the criteria score data of the telephone set 2 of “92” is stored in the criteria score data memory part 43. In such a case, the criteria score data updating part 44 updates the criteria score data of the telephone set 2 stored in the criteria score data memory part 43 to “88”, “82” and “80” in this order, according to the Ops 8 and 9 described above.

(Operational Example of Call Control Server)

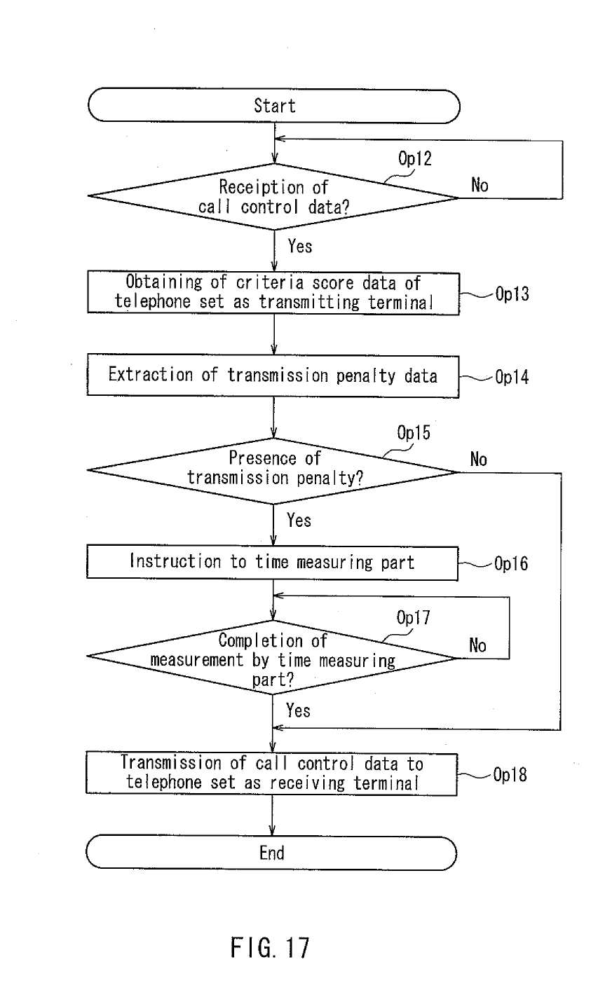

Next, processing of the call control server 5 in the call control system 1 with the above-described structure will be described with reference to FIG. 17.

FIG. 17 is a flow chart showing an example of the processing of the call control server 5. As shown in FIG. 17, if the call processing part 51 receives the call control data including the calling message from the telephone set 2 (Yes in Op 12), the call processing part 51 outputs the received call control data to the communication controlling part 52. When receiving the call control data, the communication controlling part 52 requests the criteria score data obtaining part 53 to obtain the criteria score data. The criteria score data obtaining part 53 accesses the communication processing part 45 of the criteria score data memory apparatus 4, according to the request from the communication controlling part 52, thereby obtaining the criteria score data of the telephone set 2 that is stored in the criteria score data memory part 43 (Op 13). On the other hand, unless the call processing part 51 receives the call control data from the telephone set 2 (No in Op 12), the operation returns to Op 12.

Then, the transmission delay processing part 52a of the communication controlling part 52 extracts the transmission penalty data stored in the transmission penalty memory part 55, based on the criteria score data of the telephone set 2 that is obtained in Op 13 (Op 14). If the extracted transmission penalty data shows the presence of the transmission penalty such as, for example, “4 seconds delay” (Yes in Op 15), the transmission delay processing part 52a instructs the time measuring part 58 to measure, for example, “4 seconds” (Op 16). On the other hand, if the extracted transmission penalty data shows the absence of the transmission penalty such as, for example, “none” (No in Op 15), the transmission delay processing part 52a proceeds to Op 18.

Then, when the measurement by the time measuring part 58 is completed (Yes in Op 17), or in the case of No in Op 15, the transmission delay processing part 52a outputs the call control data to the call processing part 51. Then, the call processing part 51 sends the call control data to the telephone set 3a serving as the receiving terminal via the IP telephone network N (Op 18). Thereby, the transmission from the telephone set 2 to the telephone set 3a is delayed. On the other hand, unless the measurement by the time measuring part 58 is completed (No in Op 17), the operation returns to Op 17.

As described above, according to the call control system 1 of the present embodiment, the communicating state monitoring part 32 and the receiving state monitoring part 37 monitor the state of the transmitting data that is received by the telephone set 3a. The evaluation item score data extracting part 40 extracts the evaluation item score data that is stored in the evaluation data memory part 39, based on monitoring results of the communicating state monitoring part 32 and the receiving state monitoring part 37. The transmitting terminal evaluating part 41 calculates the evaluation score of the telephone set 2, based on the evaluation item score data that is extracted by the evaluation item score data extracting part 40. Thereby, unlike the conventional structure described above, the user of the telephone set 3a is not required to input the evaluation score of the telephone set 2. Thus, it does not charge the user of the telephone set 3a with much time and labor. Moreover, since the evaluation score of the telephone set 2 is calculated based on the evaluation item score data that is stored in the evaluation data memory part 39, the evaluation scores of the telephone set 2 do not vary according to the respective users of the telephone set 3a, unlike the conventional structure described above. Moreover, the criteria score data updating part 44 increases and decreases the criteria score of the telephone set 2 that is stored in the criteria score data memory part 43, based on the evaluation score of the telephone set 2 calculated by the transmitting terminal evaluating part 41. The transmission delay processing part 52a extracts the transmission penalty data stored in the transmission penalty memory part 55 based on the criteria score of the telephone set 2, thereby providing the transmission penalty to the transmitting data sent by the telephone set 2. Examples of the transmission penalty include the delay of the transmission from the telephone set 2 to the telephone set 3a as described in the present embodiment. Thus, the number of the transmissions of unwanted calls can be decreased surely.

### Embodiment 2

In Embodiment 1, the example in which the call control server delays the transmission from the transmitting terminal to the receiving terminal was described. Whereas, in Embodiment 2, an example of replying a busy state of the receiving terminal to the transmitting terminal with respect to the transmission from the transmitting terminal to the receiving terminal will be described.

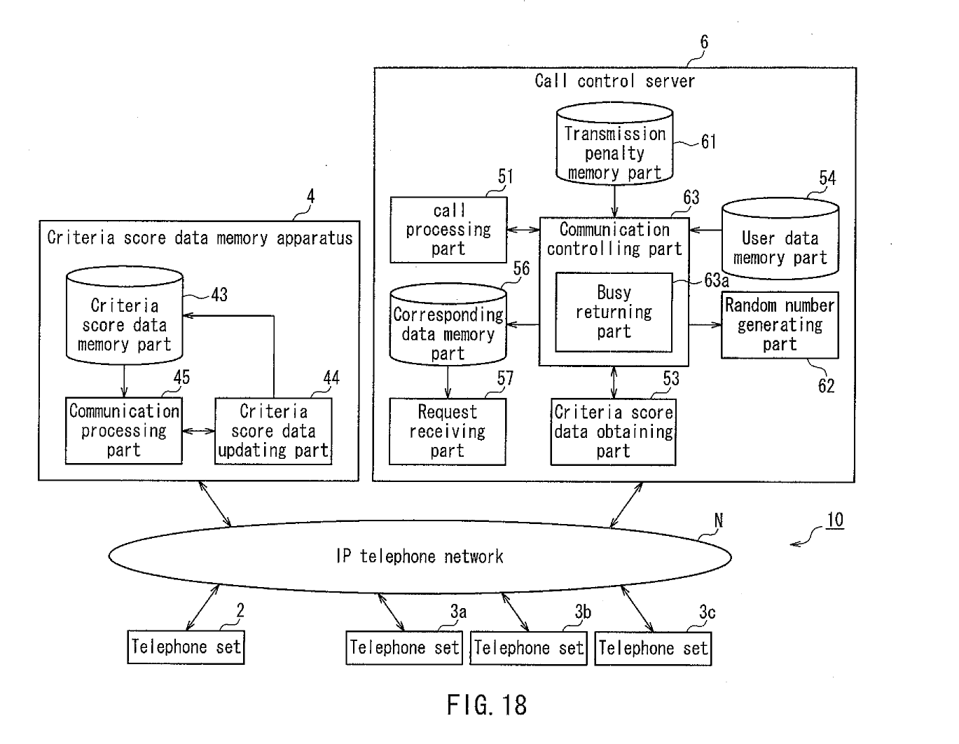

FIG. 18 is a block diagram showing a schematic structure of the call control system 10 according to the present embodiment. That is, the call control system 10 of the present embodiment is provided with a call control server 6 instead of the call control server 5 shown in FIG. 1. Incidentally, in FIG. 18, the structures having the same functions as those in FIG. 1 are denoted by the same reference numerals, and detailed explanations thereof will be omitted.

(Structure of Call Control Server)

The call control server 6 is provided with a transmission penalty memory part 61 instead of the transmission penalty memory part 55 shown in FIG. 1. Moreover, instead of the time measuring part 58 shown in FIG. 1, a random number generating part 62 is provided. Further, instead of the transmission delay processing part 52a of the communication controlling part 52 shown in FIG. 1, a busy returning part 63a of the communication controlling part 63 is provided.

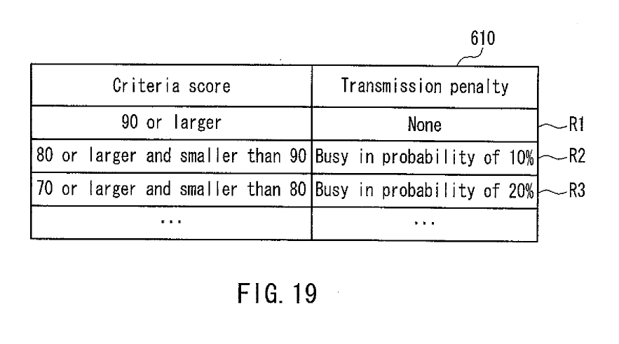

The transmission penalty memory part 61 stores a delay time of the call control data shown by the transmission penalty data that delays the call control data sent by the transmitting terminal stepwise, in each of the steps of the criteria scores of the transmitting terminal provided in a plurality of the steps. Thus, the transmission penalty memory part 61 stores the transmission penalty data as a transmission penalty data table 610 as shown in FIG. 19, for example. In the example shown in FIG. 19, in line 1, R1 of the transmission penalty data table 610, a criteria score of “90 or larger” and a transmission penalty of “none” are stored. In line 2, R2, a criteria score of “80 or larger and smaller than 90” and a transmission penalty of “busy in probability of 10%” are stored. In line 3, R3, a criteria score of “70 or larger and smaller than 80” and a transmission penalty of “busy in probability of 10%” are stored.

The random number generating part 62 has a function of generating a signal that shows a busy state at a certain probability based on the instruction from the communication controlling part 63.

The communication controlling part 63 is provided with the busy returning part 63a. The busy returning part 63a extracts the transmission penalty data stored in the transmission penalty memory part 61 based on the criteria score of the telephone set 2, and performs processing to insert a busy message into the call control data sent by the telephone set 2, based on the probability of the busy state shown by the transmission penalty data.

As an example, it is assumed that the call processing part 51 receives the call control data that is sent from the telephone set 2, and outputs the received call control data to the communication controlling part 63. Moreover, it is assumed that the criteria score data obtaining part 53 obtains “88” as the criteria score data of the telephone set 2. In such a case, the busy returning part 63a extracts the transmission penalty data of the “busy in probability of 10%” that is stored in the transmission penalty memory part 61, based on the criteria score data of the telephone set 2 of “88”. The busy returning part 63a instructs the random number generating part 62 to generate a signal showing that the probability of the busy state is 10%, based on the extracted transmission penalty data of the “busy in probability of 10%”.

Here, in the case where the random number generating part 62 generates the signal showing that the probability of the busy state is 10%, the busy returning part 63a deletes the calling message included in the call control data, and inserts a busy message therein. The busy returning part 63a outputs the call control data including the busy message to the call processing part 51. The call processing part 51 returns this call control data to the telephone set 2 serving as the transmitting terminal. Thereby, with respect to the transmission from the telephone set 2 to the telephone set 3a, the telephone set 2 shows that the telephone set 3a is in the busy state. On the other hand, unless the random number generating part 62 generates a signal showing the busy state in the remaining probability of 90%, the busy returning part 63a outputs the call control data including the calling message to the call processing part 51. The call processing part 51 sends this call control data to the telephone set 3a serving as the receiving terminal. Thereby, the transmission from the telephone set 2 to the telephone set 3a becomes possible.

(Operational Example of Call Control Server)

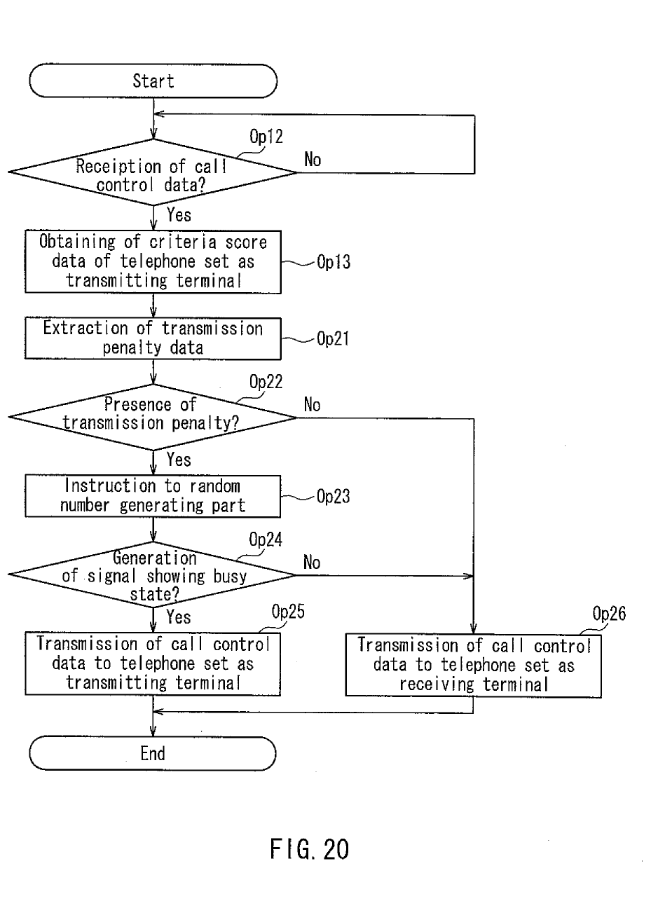

Next, operations of the call control server 6 in the call control system 10 with the above-described structure will be described with reference to FIG. 20. Incidentally, in FIG. 20, parts showing the same processing as those in FIG. 17 will be denoted by the same reference numerals, and detailed explanation thereof will be omitted.

FIG. 20 is a flow chart showing an example of processing of the call control server 6. In the processing shown in FIG. 20, Ops 12 and 13 are the same as Ops 12 and 13 shown in FIG. 17.

After Op 13, the busy returning part 63a of the communication controlling part 63 extracts the transmission penalty data stored in the transmission penalty memory part 61, based on the criteria score data of the telephone set 2 that is obtained in Op 13 (Op 21). If the extracted transmission penalty data shows that the transmission penalty such as, for example, “busy in probability of 10%” is present (Yes in Op 22), the busy returning part 63a instructs the random number generating part 62 to generate a signal showing that the probability of the busy state is 10%, for example (Op 23). On the other hand, if the extracted transmission penalty data shows the absence of the transmission penalty such as, for example, “none” (No in Op 22), the busy returning part 63a proceeds to Op 26.

Then, in the case where the random number generating part 62 generates the signal showing the busy state (Yes in Op 24), the busy returning part 63a deletes the calling message included in the call control data, and inserts the busy message therein. The busy returning part 63a outputs the call control data including the busy message to the call processing part 51. The call processing part 51 sends (replies) this call control data to the telephone set 2 (Op 25). Thereby, with respect to the transmission from the telephone set 2 to the telephone set 3a, the telephone set 2 shows that the telephone set 3a is in the busy state.

On the other hand, in the case where the random number generating part 62 does not generate the signal showing the busy state (No in Op 24) or in the case of No in Op 22, the busy returning part 63a outputs the call control data including the calling message to the call processing part 51. The call processing part 51 sends this call control data to the telephone set 3a (Op 26). Thereby, the transmission from the telephone set 2 to the telephone set 3a becomes possible.

As described above, according to the call control system 10 of the present embodiment, the busy returning part 63a extracts the transmission penalty data stored in the transmission penalty memory part 61, based on the criteria score of the telephone set 2. Thereby, the busy returning part 63a can extracts the transmission penalty data according to the increase or decrease of the criteria score of the telephone set 2. Moreover, the busy returning part 63a inserts the busy message into the call control data sent by the telephone set 2, based on the probability of the busy state shown by the transmission penalty data. Thereby, the busy state of the telephone set 3a can be replied to the telephone set 2, with respect to the transmission from the telephone set 2 to the telephone set 3a. Thereby, the number of the transmissions of the unwanted calls can be decreased surely.

### Embodiment 3

Embodiments 1 and 2 provided the example in which the telephone set serving as the receiving terminal is provided with the evaluation data memory part, the criteria score data memory apparatus is provided with the criteria score data memory part, and the call control server is provided with the transmission penalty memory part. On the other hand, Embodiment 3 will provide an example in which the criteria score data memory apparatus is provided with the evaluation data memory part, the criteria score data memory part and the transmission penalty memory part collectively.

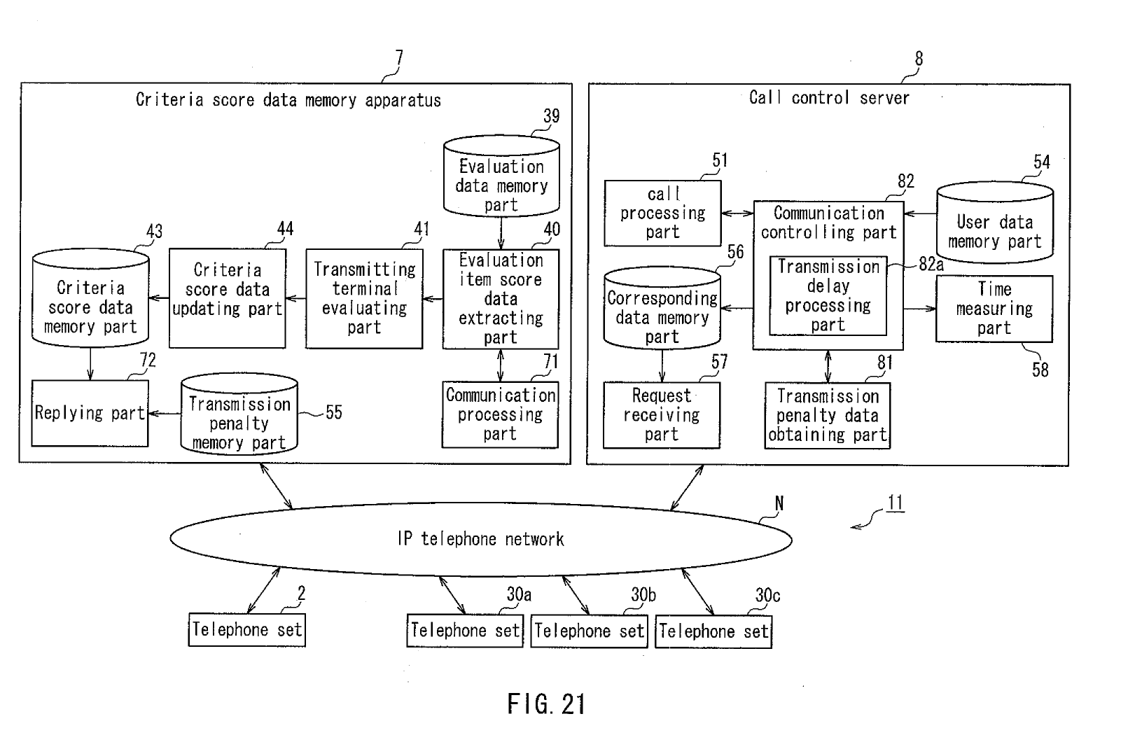

FIG. 21 is a block diagram showing a schematic structure of a call control system 11 according to the present embodiment. That is, the call control system 11 of the present embodiment is provided with telephone sets 30a to 30c instead of the telephone sets 3a to 3c shown in FIG. 1. Moreover, the call control system 11 of the present embodiment is provided with a criteria score data memory apparatus 7 instead of the criteria score data memory apparatus 4 shown in FIG. 1. Further, the call control system 11 of the present embodiment is provided with a call control server 8 instead of the call control server shown in FIG. 1. Incidentally, in FIG. 21, structures having the same functions as those in FIG. 1 will be denoted by the same reference numerals, and detailed explanations thereof will be omitted.

(Structure of Receiving Terminal)

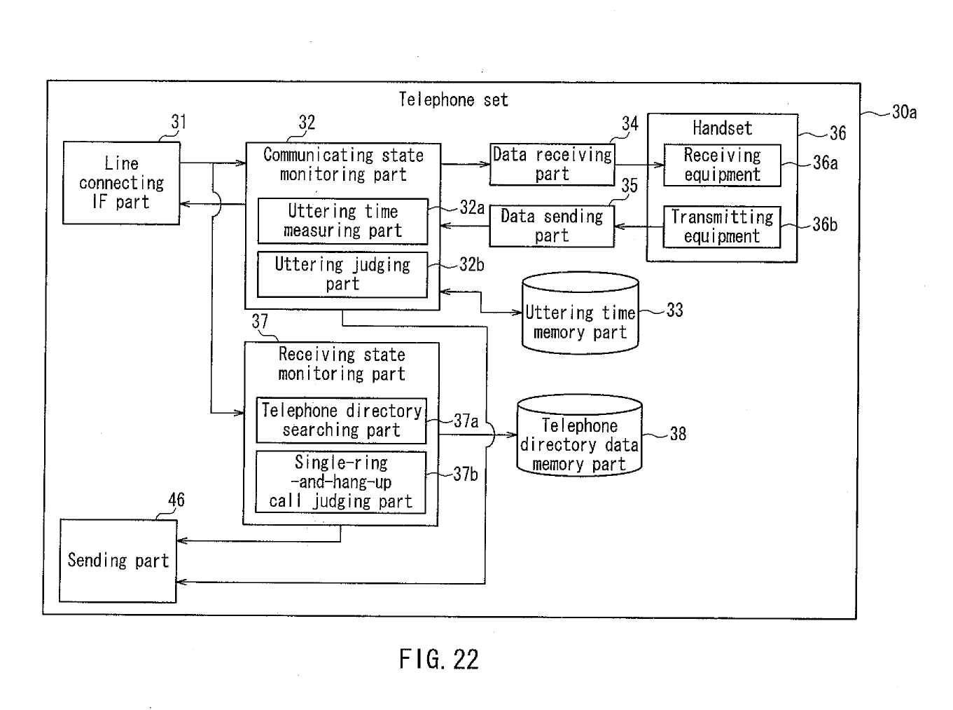

FIG. 22 is a block diagram showing a detailed structure of the telephone set (receiving terminal) 30a. Structures of the telephone sets 30b and 30c are the same as the structure of the telephone set 30a shown in FIG. 22. The telephone set 30a shown in FIG. 22 is provided with a sending part 46 instead of the sending part 42 shown in FIG. 2. Incidentally the evaluation data memory part 39, the evaluation item score data extracting part 40 and the transmitting terminal evaluating part 41 shown in FIG. 2 are provided in the criteria score data memory apparatus 7 shown in FIG. 21.

The sending part 46 sends the telephone number of the telephone set 2 that is extracted by the telephone directory searching part 37a and the monitoring results that are output from the communicating state monitoring part 32 and the receiving state monitoring part 37) to the criteria score data memory apparatus 7 via the IP telephone network N.

(Structure of Criteria Score Data Memory Apparatus)

The criteria score data memory apparatus 7 shown in FIG. 21 is further provided with the evaluation data memory part 39, the evaluation item score data extracting part 40 and the transmitting terminal evaluating part 41 in the telephone set 3a shown in FIG. 2, in addition to the criteria score data memory apparatus 4 shown in FIG. 1. Moreover, the criteria score data memory apparatus 7 shown in FIG. 21 is further provided with the transmission penalty memory part 55 in the call control server 5 shown in FIG. 1, in addition to the criteria score data memory apparatus 4 shown in FIG. 1. Moreover, the criteria score data memory apparatus 7 shown in FIG. 21 is provided with a communication processing part 71, instead of the communication processing part 45 shown in FIG. 1. Further, the criteria score data memory apparatus 7 shown in FIG. 21 is further provided with a replying part 72, in addition to the criteria score data memory apparatus 4 shown in FIG. 1.

The communication processing part 71 receives the telephone number of the telephone set 2 and the monitoring results by the communicating state monitoring part 32 and the receiving state monitoring part 37, from the sending part 46 of the telephone set 30a. The communication processing part 71 outputs the received telephone number of the telephone set 2 and the received monitoring results by the communicating state monitoring part 32 and the receiving state monitoring part 37, to the evaluation item score data extracting part 40.

The evaluation item score data extracting part 40 extracts the evaluation item score data stored in the evaluation data memory part 39, based on the monitoring results by the communicating state monitoring part 32 and the receiving state monitoring part 37. The transmitting terminal evaluating part 41 calculates the evaluation score of the telephone set 2 serving as the transmitting terminal, based on the evaluation item score data extracted by the evaluation item score data extracting part 39. The criteria score data updating part 44 updates the criteria score data of the telephone set 2 that is stored in the criteria score data memory part 43, based on the telephone number and the evaluation score of the telephone set 2.

The replying part 72 extracts the criteria score data of the telephone set 2 stored in the criteria score data memory part 43, according to the request from a below-described transmission penalty data obtaining part 81 of the call control server 8, and extracts the transmission penalty data stored in the transmission penalty memory part 55, based on the extracted criteria score data of the telephone set 2. The replying part 72 sends the extracted transmission penalty data to the transmission penalty data obtaining part 81.

(Structure of Call Control Server)

The call control server 8 shown in FIG. 21 is provided with the transmission penalty data obtaining part 81 instead of the criteria score data obtaining part 53 shown in FIG. 1. Moreover, the call control server 8 shown in FIG. 21 is provided with a communication controlling part 82 instead of the communication controlling part 52 shown in FIG. 1. Incidentally, the transmission penalty memory part 55 shown in FIG. 1 is provided in the criteria score data memory apparatus 7 shown in FIG. 21.

According to the request from the communication controlling part 82, the transmission penalty data obtaining part 81 accesses the replying part 72 of the criteria score data memory apparatus 7, and obtains the transmission penalty data stored in the transmission penalty memory part 55. The transmission penalty data obtaining part 81 outputs the obtained transmission penalty data to the communication controlling part 82.

When receiving the call control data output from the call processing part 51, the communication controlling part 82 requests the transmission penalty data obtaining part 81 to obtain the transmission penalty data from the criteria score data memory apparatus 7, based on the telephone number of the telephone set 2 included in the call control data. When the transmission penalty data obtaining part 81 obtains the transmission penalty data, the transmission delay processing part 82a of the communication controlling part 82 performs processing to maintain the call control data that is sent by the telephone set 2, based on the delay time of the call control data that is shown by the obtained transmission penalty data. Incidentally, in the present embodiment, the communication controlling part 82, the transmission penalty data obtaining part 81 and the replying part 72 of the criteria score data memory apparatus 7 that are described above correspond to the communication controlling part described in the claims.

By the way, the above description provided the example in which the criteria score data memory apparatus is provided with the evaluation data memory part, the criteria score data memory part and the transmission penalty memory part collectively in the structure of Embodiment 1, but the present embodiment is not limited to this. That is, needless to say, the criteria score data memory apparatus may be provided with the evaluation data memory part, the criteria score data memory part and the transmission penalty memory part collectively also in the structure of Embodiment 2.

As described above, according to the call control system 11 of the present embodiment, the criteria score data memory apparatus 7 is provided with the evaluation data memory part 39, the criteria score data memory part 43 and the transmission penalty memory part 55 collectively. Since the criteria score data memory apparatus 7 are provided with these memory parts 39, 43 and 55 collectively, an administrator can maintain these memory parts 39, 43 and 55 easily. For example, in the case of changing the evaluation item score data stored in the evaluation data memory part 39, it is necessary to change the evaluation item score data that is stored in the evaluation data memory part of each telephone set, according to the structure in which the evaluation data memory part 39 is provided in the telephone set serving as the receiving terminal on the assumption. On the other hand, according to the criteria score data memory apparatus 7 of the present invention, since the criteria score data memory apparatus 7 is provided with the evaluation data memory part 39, it is necessary to change only the evaluation item score data that is stored in this evaluation data memory part 39.

### Embodiment 4

Embodiments 1 to 3 provided the example in which one call control server is provided, and controls the calls of the telephone set serving as the transmitting terminal and the telephone set serving as the receiving terminal. Whereas, Embodiment 4 provides an example in which a plurality of the call control servers are provided, and cooperate to control the calls of the telephone set serving as the transmitting terminal and the telephone set serving as the receiving terminal.

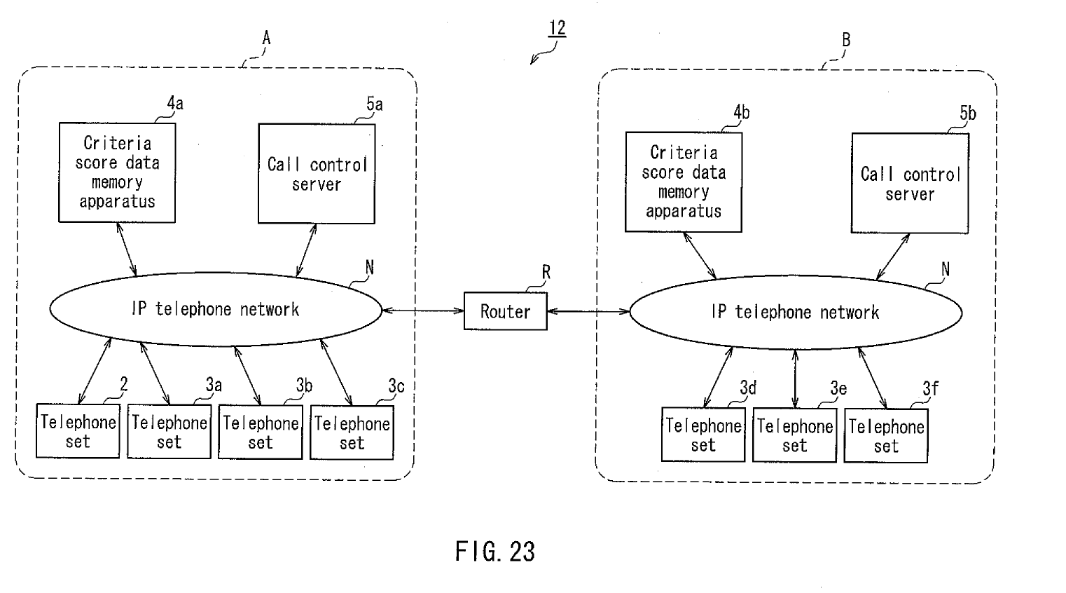

FIG. 23 is a block diagram showing a schematic structure of the call control system 12 according to the present embodiment. That is, the call control system 12 of the present embodiment is a system provided by a telecommunication carrier (carrier) A and a telecommunication carrier (carrier) B. The carrier A is provided with the telephone sets 2 and 3a to 3c, a criteria score data memory apparatus 4a and a call control server 5a. The carrier B is provided with telephone sets 3d to 3f, a criteria score data memory apparatus 4b and a call control server 5b. The carrier A and the carrier B are connected via a router R. Incidentally, in FIG. 23, the criteria score data memory apparatuses 4a and 4b have the same functions as that of the criteria score data memory apparatus 4 shown in FIG. 1. Moreover, the call control servers 5a and 5b have the same functions as the call control server 5 shown in FIG. 1. Further, the telephone sets 3a to 3f have the same functions as that of the telephone set 3a shown in FIG. 1.

The present embodiment provides an example in which a transmitter of unwanted calls transmits the unwanted calls to the telephone sets (receiving terminals) 3d to 3f that are provided in the carrier B by using the telephone set (transmitting terminal) 2 that is provided in the carrier A. In the present embodiment, it is assumed that the transmitter of the unwanted calls transmits the unwanted calls to the telephone sets 3d, 3e and 3f in this order by using the telephone set 2.

The call control server 5a receives call control data including the calling message sent from the telephone set 2. The call control server 5a sends the received call control data to the call control server 5b via the router R. The call control server 5b sends the received call control data to the telephone set 3d. Thereby, even in the case where the carriers are different, the call control servers 5a and 5b cooperate so as to establish the calls of the telephone sets 2 and 3d. It should be noted that the case of the telephone sets 2, 3e and 3f is the same as the case of the telephone sets 2 and 3d.

Here, the criteria score data memory apparatus 4b receives evaluation scores of the telephone set 2 that are sent by the telephone sets 3d to 3f. The criteria score data memory apparatus 4b updates the criteria score data of the telephone set 2 that is stored in the criteria score data memory apparatus 4b, based on the received evaluation scores of the telephone set 2. Thus, a transmission penalty is provided to the call control data that is sent from the telephone set 2 in the carrier A on the transmitter side, in the call control server 5b in the carrier B on the receiver side.

In the present embodiment, in the case where the transmission of the unwanted call by the telephone set 2 continues, the criteria score data memory apparatus 4b in the carrier B on the receiver side has a function of transmitting the criteria score data of the telephone set 2 that is stored in the criteria score data memory apparatus 4b to the criteria score data memory apparatus 4a in the carrier A on the transmitter side. For example, in the case where the criteria score data of the telephone set 2 stored in the criteria score data memory apparatus 4b is decreased to a certain score, the criteria score data memory apparatus 4b transmits the criteria score data of the telephone set 2 stored in the criteria score data memory apparatus 4b to the criteria score data memory apparatus 4a. Thereby, in the call control server 5a in the carrier A on the transmitter side, the transmission penalty can be provided to the call control data sent from the telephone set 2.

By the way, the above description provided the example in which the criteria score data memory apparatus 4b in the carrier B on the receiver side transmits the criteria score data of the telephone set 2 that is stored in the criteria score data memory apparatus 4b, to the criteria score data memory apparatus 4a in the carrier A on the transmitter side, but the present embodiment is not limited to this. For example, the criteria score data memory apparatuses 4a and 4b may be synchronized in real time so that the criteria score data of the telephone set 2 stored in the criteria score data memory apparatus 4a and the criteria score data of the telephone set 2 stored in the criteria score data memory apparatus 4b coincide with each other. Thereby, even in the case where the telephone set 2 used by the transmitter of the unwanted calls is changed from the carrier A to the carrier B, the transmission penalty can be provided to the call control data that is sent from the telephone set 2 in the call control server 5b in the carrier B.

The above description provided the examples in which the transmission penalty to be provided to the call control data that is sent from the transmitting terminal was the delay of the transmission from the transmitting terminal to the receiving terminal in Embodiment 1, and the reply showing the busy state of the receiving terminal to the transmitting terminal, with respect to the transmission from the transmitting terminal to the receiving terminal in Embodiment 2, but the present invention is not limited to these. For example, the transmission penalty may also be stop of the transmission from the transmitting terminal to the receiving terminal, a reply including an advertisement call that is supplied from the call control server to the transmitting terminal, with respect to the transmission from the transmitting terminal to the receiving terminal, or the like. Further, the transmission penalty may be an increase of a charge of the transmitting terminal or the like. That is, the transmission penalty is arbitrary, as long as it can provide the transmission penalty to the call control data that is sent from the transmitting terminal.

Moreover, Embodiments 1 and 2 provided the example in which the transmission penalty is provided to the call control data sent from the transmitting terminal, but the present invention is not limited to this. That is, the transmission penalty may also be provided to voice data that is sent from the transmitting terminal. For example, the voice data sent from the transmitting terminal may be delayed. It should be noted that, in the case of using a call control server (SIP server) by an SIP, since the voice data is transmitted and received between the transmitting terminal and the receiving terminal without interposing the SIP server, an apparatus that delays the voice data is necessary besides the SIP server.

Further, Embodiments 1 to 4 provided the example in which the telephone sets, the criteria score data memory apparatus and the call control server are connected via the IP telephone network, but the present invention is not limited to this. For example, the telephone sets, the criteria score data memory apparatus and the call control server may be connected via a public switched telephone network (PSTN). In this case, a line switchboard and a multiplexer to be connected to the public switched telephone network serve as the call control server.

As described above, the present invention is useful as a call control system, a communication terminal, a criteria value data memory apparatus and a program that can decrease the number of transmissions of unwanted calls surely without charging a user with much time and labor.

Embodiments described above are considered in all respects as illustrative and not restrictive. The scope of the invention is indicated by the appended claims rather than by the foregoing description. All changes that come within the meaning and range of equivalency of the appended claims are intended to be embraced therein.

What is claimed is:

1. A call control system comprising a communication controlling part that controls calls of a transmitting terminal and a receiving terminal such that the receiving terminal receives transmitting data including call control data or voice data sent by the transmitting terminal,
the call control system comprising:
a monitoring part that monitors a state of transmitting data received by the receiving terminal;
an evaluation data memory part that stores evaluation item data showing an evaluation item of the transmitting data and evaluation item value data showing an evaluation value of the evaluation item;
an extracting part that extracts the evaluation item value data stored in the evaluation data memory part based on a result of monitoring by the monitoring part;
a transmitting terminal evaluating part that calculates an evaluation value of the transmitting terminal based on the evaluation item value data extracted by the extracting part;
a criteria value data memory part that stores criteria value data showing a criteria value of the transmitting terminal serving as a criteria to control the calls of the transmitting terminal and the receiving terminal;
a updating part that increases and decreases the criteria value of the transmitting terminal based on the evaluation value of the transmitting terminal calculated by the transmitting terminal evaluating part; and
a transmission penalty memory part that stores a transmission penalty data providing a transmission penalty to the transmitting data sent by the transmitting terminal according to each step of the criteria value of the transmitting terminal provided in a plurality of the steps,
wherein the communication controlling part extracts the transmission penalty data stored in the transmission penalty memory part based on the criteria value of the transmitting terminal, and provides the transmission penalty to the transmitting data sent by the transmitting terminal.

2. The call control system according to claim 1, wherein
the transmission penalty memory part stores a delay time of the call control data shown by the transmission penalty data that delays the call control data sent by the transmitting terminal stepwise, in each step of the criteria value of the transmitting terminal provided in the plurality of the steps, and
the communication controlling part extracts the transmission penalty data stored in the transmission penalty memory part based on the criteria value of the transmitting terminal, and maintains the call control data sent by the transmitting terminal based on the delay time of the call control data shown by the transmission penalty data.

3. The call control system according to claim 1, wherein
the transmission penalty memory part stores a probability of a busy state shown by the transmission penalty data that inserts a busy message into the call control data sent by the transmitting terminal stepwise, in each step of the criteria value of the transmitting terminal provided in the plurality of the steps, and
the communication controlling part extracts the transmission penalty data stored in the transmission penalty memory part based on the criteria value of the transmitting terminal, and inserts the busy message into the call control data sent by the transmitting terminal based on a probability of the busy state shown by the transmission penalty data.

4. The call control system according to claim 1, wherein the monitoring part includes an uttering judging part that monitors at least one state of an uttering state in which the transmitter of the transmitting terminal utters and a communicating state between the transmitter of the transmitting terminal and the receiver of the receiving terminal.

5. The call control system according to claim 4, wherein, in a case where the uttering judging part judges that communication between the transmitter and the receiver is normal communication based on at least one state of the uttering state and the communicating state, the uttering terminal evaluating part calculates an evaluation value of the transmitting terminal so as not to provide the transmission penalty to the transmitting data sent by the transmitting terminal.

6. The call control system according to claim 1 further comprising a telephone directory data memory part that stores telephone directory data showing a telephone number corresponding to a full name or a name, wherein the monitoring part includes a telephone directory searching part that extracts the telephone number of the transmitting terminal from the call control data sent by the transmitting terminal, and judges whether the telephone number of the transmitting terminal is stored in the telephone directory data memory part or not.

7. The call control system according to claim 1, wherein the monitoring part includes a call judging part that judges whether the call control data sent by the transmitting terminal shows establishment of the calls of the transmitting terminal and the receiving terminal or not.

8. A receiving terminal using in a call control system,
the call control system comprising:
a communication controlling part that controls calls of a transmitting terminal and the receiving terminal such that the receiving terminal receives transmitting data including call control data or voice data sent by the transmitting terminal;
a criteria value data memory part that stores criteria value data showing a criteria value of the transmitting terminal serving as a criteria that controls the calls of the transmitting terminal and the receiving terminal;
a updating part that increases and decreases the criteria value of the transmitting terminal; and
a transmission penalty memory part that stores transmission penalty data providing a transmission penalty to the transmitting data sent by the transmitting terminal according to each step of the criteria value of the transmitting terminal provided in a plurality of the steps,
the communication terminal comprising:
a monitoring part that monitors a state of the transmitting data received by the receiving terminal;
an evaluation data memory part that stores evaluation item data showing an evaluation item of the transmitting data and evaluation item value data showing an evaluation value of the evaluation item;
an extracting part that extracts the evaluation item value data stored in the evaluation data memory part based on a result of monitoring by the monitoring part;
a transmitting terminal evaluating part that calculates the evaluation value of the transmitting terminal based on the evaluation item value data extracted by the extracting part; and
a sending part that sends the evaluation value of the transmitting terminal calculated by the transmitting terminal evaluating part to the updating part.

9. A criteria value data memory apparatus using in a call control system,
the call control system comprising:
a communication controlling part that controls calls of a transmitting terminal and a receiving terminal such that the receiving terminal receives transmitting data including call control data or voice data sent by the transmitting terminal;
a monitoring part that monitors a state of the transmitting data received by the receiving terminal;
an evaluation data memory part that stores evaluation item data showing an evaluation item of the transmitting data and evaluation item value data showing an evaluation value of the evaluation item;
an extracting part that extracts the evaluation item value data stored in the evaluation data memory part based on a result of monitoring by the monitoring part;
a transmitting terminal evaluating part that calculates the evaluation value of the transmitting terminal based on the evaluation item value data extracted by the extracting part; and
a transmission penalty memory part that stores transmission penalty data providing a transmission penalty to the transmitting data sent by the transmitting terminal according to each step of the criteria value of the transmitting terminal provided in a plurality of the steps,
the criteria value data memory apparatus comprising:
a criteria value data memory part that stores criteria value data showing a criteria value of the transmitting terminal serving as a criteria to control the calls of the transmitting terminal and the receiving terminal; and
a updating part that increases and decreases the criteria value of the transmitting terminal based on the evaluation value of the transmitting terminal calculated by the transmitting terminal evaluating part.

10. A criteria value data memory apparatus using in a call control system,
the call control system comprising:
a communication controlling part that controls calls of a transmitting terminal and a receiving terminal such that the receiving terminal receives transmitting data including call control data or voice data sent by the transmitting terminal; and
a monitoring part that monitors a state of the transmitting data received by the receiving terminal,
the criteria value data memory apparatus comprising:
an evaluation data memory part that stores evaluation item data showing an evaluation item of the transmitting data and evaluation item value data showing an evaluation value of the evaluation item;
an extracting part that extracts the evaluation item value data stored in the evaluation data memory part based on a result of monitoring by the monitoring part;
a transmitting terminal evaluating part that calculates the evaluation value of the transmitting terminal based on the evaluation item value data extracted by the extracting part;
a criteria value data memory part that stores criteria value data showing a criteria value of the transmitting terminal serving as a criteria to control the calls of the transmitting terminal and the receiving terminal;
a updating part that increases and decreases the criteria value of the transmitting terminal based on the evaluation value of the transmitting terminal calculated by the transmitting terminal evaluating part; and
a transmission penalty memory part that stores transmission penalty data providing a transmission penalty to the transmitting data sent by the transmitting terminal according to each step of the criteria value of the transmitting terminal provided in a plurality of the steps.

11. A call controlling method in which a call control system controls calls of a transmitting terminal and a receiving terminal such that a receiving terminal receives transmitting data sent by the transmitting terminal,
the call control system comprising:
an evaluation data memory part that stores evaluation item data showing an evaluation item of the transmitting data including call control data or voice data sent by the transmitting terminal and evaluation item value data showing an evaluation value of the evaluation item;
a criteria value data memory part that stores criteria value data showing a criteria value of the transmitting terminal serving as a criteria to control the calls of the transmitting terminal and the receiving terminal; and
a transmission penalty memory part that stores transmission penalty data providing a transmission penalty to the transmitting data sent by the transmitting terminal according to each step of the criteria value of the transmitting terminal provided in a plurality of the steps,
the call controlling method comprising:
a monitoring operation of monitoring a state of the transmitting data received by the receiving terminal;
an extracting operation of extracting the evaluation item value data stored in the evaluation data memory part based on a result of the monitoring in the monitoring operation;
a transmitting terminal evaluating operation of calculating the evaluation value of the transmitting terminal based on the evaluation item value data extracted in the extracting operation;
a updating operation of increasing and decreasing the criteria value of the transmitting terminal based on the evaluation value of the transmitting terminal calculated in the transmitting terminal evaluating operation; and
a communication controlling operation of extracting the transmission penalty data stored in the transmission penalty memory part based on the criteria value of the transmitting terminal and providing the transmission penalty to the transmitting data sent by the transmitting terminal.

12. A recording medium storing a program that allows one or a plurality of computers to execute communication control processing of controlling calls of a transmitting terminal and a receiving terminal such that the receiving terminal receives transmitting data sent by the transmitting terminal,
the computer comprising:
an evaluation data memory part that stores evaluation item data evaluation item data showing an evaluation item of the transmitting data including call control data or voice data sent by the transmitting terminal and evaluation item value data showing an evaluation value of the evaluation item;
a criteria value data memory part that stores criteria value data showing a criteria value of the transmitting terminal serving as a criteria to control the calls of the transmitting terminal and the receiving terminal; and
a transmission penalty memory part that stores transmission penalty data providing a transmission penalty to the transmitting data sent by the transmitting terminal according to each step of the criteria value of the transmitting terminal provided in a plurality of the steps,
the program allowing the computer to execute:
monitor processing of monitoring a state of the transmitting data received by the receiving terminal;
extraction processing of extracting the evaluation item value data stored in the evaluation data memory part based on a result of the monitoring in the monitor processing;
transmitting terminal evaluation processing of calculating an evaluation value of the transmitting terminal based on the evaluation item value data extracted in the extraction processing; and
update processing of increasing and decreasing the criteria value of the transmitting terminal based on the evaluation value of the transmitting terminal calculated in the transmitting terminal evaluation processing,
wherein the communication control processing allows the computer to execute processing of extracting the transmission penalty data stored in the transmission penalty memory part based on the criteria value of the transmitting terminal and providing the transmission penalty to the transmitting data sent by the transmitting terminal.

13. A recording medium storing a program that allows a computer to function as the criteria value data memory apparatus according to claim 9, wherein the program allows the computer to execute:
criteria value data storing processing of storing the criteria value data showing the criteria value of the transmitting terminal serving as the criteria to control the calls of the transmitting terminal and the receiving terminal into the criteria value data memory part; and
update processing of increasing and decreasing the criteria value of the transmitting terminal based on the evaluation value of the transmitting terminal calculated by the transmitting terminal evaluating part.
